(19) United States
(12) Patent Application Publication
(10) Pub. No.: US 2026/0188865 A1
(43) Pub. Date: Jul. 2, 2026

(54) SECONDARY BATTERY

(71) Applicant: MURATA MANUFACTURING CO., LTD., Kyoto (JP)

(72) Inventor: Masayuki IHARA, Kyoto (JP)

(21) Appl. No.: 19/371,410

(22) Filed: Oct. 28, 2025

(30) Foreign Application Priority Data
Dec. 27, 2024 (JP) 2024-232925

(51) Int. Cl. H01M 50/534; H01M 4/02; H01M 4/40; H01M 4/485; H01M 10/0525; H01M 10/0587

(52) U.S. Cl. CPC H01M 50/534; H01M 4/405; H01M 4/485; H01M 10/0525; H01M 10/0587; H01M 2004/028

(57) ABSTRACT

A secondary battery is provided and includes a secondary battery including a positive electrode, a negative electrode, and an electrolytic solution. The positive electrode includes a positive electrode current collector containing aluminum and a positive electrode active material layer provided on the positive electrode current collector. The positive electrode active material layer contains a lithium-containing compound, a lithium carbonate, and a lithium hydroxide. The non-aqueous electrolytic solution contains an electrolyte salt and an organic solvent. The electrolyte contains a bis(fluorosulfonyl)imide salt. The surface of the positive electrode current collector contains sulfur. The photoelectron spectrum obtained in X-ray photoelectron spectroscopy for the surface of the positive electrode current collector has a first signal with a peak in a range of 164.1 eV or more and 164.5 eV or less and a second signal with a peak in a range of 168.9 eV or more and 169.3 eV or less. The ratio of the sum of the signal intensity of the first signal and the signal intensity of the second signal to the sum total of the signal intensities of the S2p spectrum is 0.97 or less.

### CROSS REFERENCE TO RELATED APPLICATIONS

The present application claims priority to Japanese patent application no. 2024-232925, filed on Dec. 27, 2024, the entire contents of which are incorporated herein by reference.

### BACKGROUND

The present disclosure relates to a secondary battery.

A secondary battery is disclosed in which a positive electrode has a current collector for a positive electrode, made of aluminum or an aluminum alloy, and an electrolytic solution contains a lithium bis(fluorosulfonyl)imide.

### SUMMARY

The present disclosure relates to a secondary battery.

However, the secondary battery described in the Background section has the possibility of degrading the charge-discharge characteristics due to the electrolytic solution.

The present disclosure, in an embodiment, relates to providing improving charge-discharge characteristics.

A secondary battery according to an aspect of the present disclosure is a secondary battery including: a positive electrode; a negative electrode; and an electrolytic solution, in which the positive electrode includes a positive electrode current collector containing aluminum, and a positive electrode active material layer provided on the positive electrode current collector, the positive electrode active material layer contains a lithium-containing compound, a lithium carbonate, and a lithium hydroxide, the electrolytic solution contains an electrolyte and a solvent, the electrolyte contains a bis(fluorosulfonyl)imide salt, the surface of the positive electrode current collector contains sulfur, a photoelectron spectrum obtained in X-ray photoelectron spectroscopy for the surface of the positive electrode current collector has a first signal with a peak in a range of 164.1 eV or more and 164.5 eV or less and a second signal with a peak in a range of 168.9 eV or more and 169.3 eV or less, and the ratio of the sum of the signal intensity of the first signal and the signal intensity of the second signal to the sum total of the signal intensities of the S2p spectrum is 0.97 or less.

The present disclosure can improve charge-discharge characteristics according to an embodiment.

### BRIEF DESCRIPTION OF THE FIGURES

FIG. 1 is a perspective view illustrating a configuration of a secondary battery according to an embodiment;

FIG. 2 is an enlarged sectional view illustrating the configuration of the battery element illustrated in FIG. 1;

FIG. 3 is a diagram showing an S2p spectrum of XPS for the surface of a positive electrode current collector according to an embodiment;

FIG. 4 is a diagram showing an F1s spectrum of XPS for the surface of the positive electrode current collector according to an embodiment; and

FIG. 5 is a diagram showing an Al2p spectrum of XPS for the surface of the positive electrode current collector according to an embodiment.

### DETAILED DESCRIPTION

The present disclosure will be further described including with reference to the drawings according to an embodiment. Note that the present disclosure is not limited thereby.

A secondary battery according to an embodiment will be described. The secondary battery according to an embodiment is a secondary battery that utilizes occlusion and release of an electrode reactant to obtain a battery capacity and includes a positive electrode, a negative electrode, and an electrolytic solution.

The type of the electrode reactant is not particularly limited, and is specifically a light metal such as an alkali metal and an alkaline earth metal. Specific examples of the alkali metal include lithium, sodium, and potassium. Specific examples of the alkaline earth metal include beryllium, magnesium, and calcium. In addition, the type of the electrode reactant may be another light metal such as aluminum.

In the following description, a case where the electrode reactant is lithium will be described as an example. A secondary battery that utilizes occlusion and release of lithium to obtain a battery capacity is, for example, a lithium ion secondary battery. In the lithium ion secondary battery, lithium is occluded and released in an ionic state.

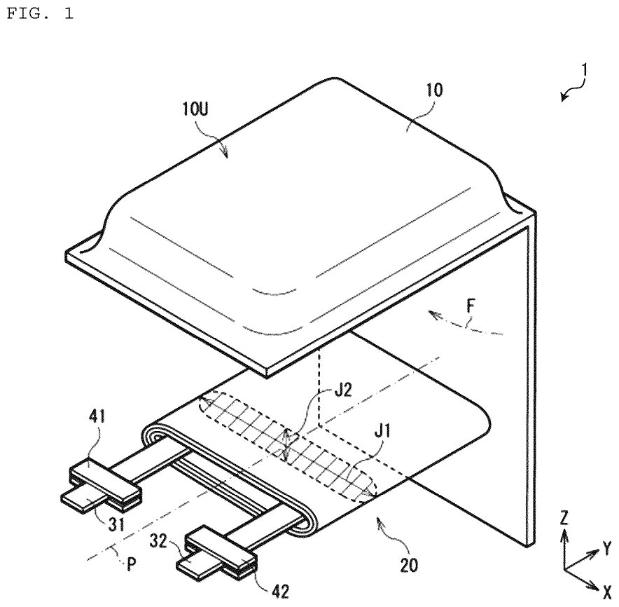

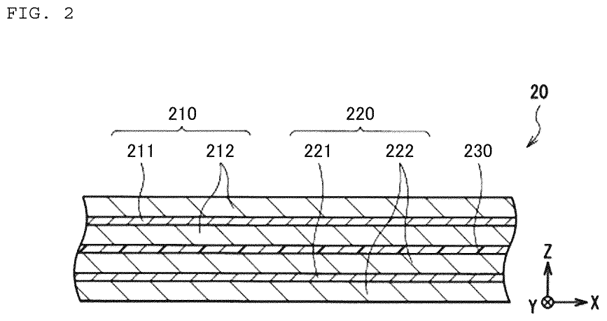

FIG. 1 is a perspective view illustrating a configuration of a secondary battery according to an embodiment. FIG. 2 is an enlarged sectional view illustrating the configuration of the battery element illustrated in FIG. 1. FIG. 1 illustrates an exterior film 10 and a battery element 20 separated from each other, and a section of the battery element 20 is indicated by a broken line. FIG. 2 illustrates a section of only a part of the battery element 20.

As illustrated in FIGS. 1 and 2, the secondary battery 1 includes the exterior film 10, the battery element 20, a positive electrode lead 31, a negative electrode lead 32, and sealing films 41 and 42.

For the secondary battery 1 according to FIG. 1, the exterior film 10 is used as an exterior member for housing the battery element 20 as mentioned above. Thus, the secondary battery 1 illustrated in FIG. 1 is a so-called laminate film type secondary battery.

As illustrated in FIG. 1, the exterior film 10 is an exterior member that houses the battery element 20, and has a sealed bag-shaped structure in which the battery element 20 is housed. Thus, the exterior film 10 houses a positive electrode 210, a negative electrode 220, a separator 230, and an electrolytic solution, not shown, which will be described later.

In the example of FIG. 1, the exterior film 10 is a single film-shaped member, and is folded in a folding direction F. The exterior film 10 is provided with a recess 10U for housing the battery element 20. The recess 10U is a so-called deep drawn part.

Specifically, the exterior film 10 is a three-layer laminate film that has a fusion layer, a metal layer, and a surface protective layer laminated in this order from the inside. With the exterior film 10 folded, mutually facing outer peripheral edges of the fusion layer are fused to each other. The fusion layer contains a polymer compound such as a polypropylene. The metal layer contains a metal material such as aluminum. The surface protective layer contains a polymer compound such as nylon. Note that the configuration (number of layers) of the exterior film 10 is not particularly limited, and may have one layer, two layers, or four or more layers.

As illustrated in FIGS. 1 and 2, the positive electrode lead 31 is a positive electrode wiring connected to a positive electrode current collector 211 of the positive electrode 210, and is extended to the outside of the exterior film 10. The positive electrode lead 31 contains at least one or more conductive materials such as metal materials, and specific examples of the conductive materials include aluminum. Further, the shape of the positive electrode lead 31 is not particularly limited, and is, for example, a thin plate shape, a mesh shape, or the like.

As illustrated in FIGS. 1 and 2, the negative electrode lead 32 is a negative electrode wiring connected to a negative electrode current collector 221 of the negative electrode 220, and is extended to the outside of the exterior film 10. The negative electrode lead 32 contains at least one or more conductive materials such as metal materials. Specific examples of the conductive materials include copper. Further, the shape of the negative electrode lead 32 is not particularly limited, and is, for example, a thin plate shape, a mesh shape, or the like.

As illustrated in FIG. 1, the sealing film 41 is inserted between the exterior film 10 and the positive electrode lead 31. In addition, as illustrated in FIG. 1, the sealing film 42 is inserted between the exterior film 10 and the negative electrode lead 32. However, one or both of the sealing films 41 and 42 may be omitted.

The sealing film 41 is a sealing member that prevents entry of outside air and the like into the exterior film 10. The sealing film 41 contains a polymer compound such as a polyolefin that has close contact with the positive electrode lead 31. Specific examples of the polymer compound include a polypropylene.

The sealing film 42 is a sealing member that prevents entry of outside air and the like into the exterior film 10. The sealing film 42 contains a polymer compound such as a polyolefin that has close contact with the negative electrode lead 32. Specific examples of the polymer compound include a polypropylene.

The battery element 20 is housed in the space of the recess 10U of the exterior film 10. The battery element 20 is a so-called power generation element. As illustrated in FIGS. 1 and 2, the battery element 20 includes the positive electrode 210, the negative electrode 220, the separator 230, and an electrolytic solution, not shown.

In the example of FIG. 1, the battery element 20 is a so-called wound electrode body. Thus, the positive electrode 210 and the negative electrode 220 are wound around a winding axis P while facing each other with the separator 230 interposed therebetween. In the following description, a direction along the winding axis P may be referred to as a Y direction, and a longer direction of the battery element 20, of direction perpendicular to the winding axis P, may be referred to as an X direction, whereas a shorter direction of the battery element 20, of the directions perpendicular to the winding axis P, may be referred to as a Z direction.

In the example of FIG. 1, the battery element 20 has a flattened three-dimensional shape. More specifically, the shape of a section (a section along the XZ plane) of the battery element 20, intersecting with the winding axis P of the battery element 20, is a flattened shape defined by a major axis J1 and a minor axis J2. The major axis J1 is an imaginary axis extending in the X-axis direction, and has a length larger than the length of the minor axis J2. The minor axis J2 is an imaginary axis extending in the Z-axis direction, and has a length smaller than the length of the major axis J1. Thus, the sectional shape of the battery element 20 is a flattened substantially elliptical shape. Note that the three-dimensional shape of the battery element 20 is an example, and is not limited to the above-mentioned shape.

The positive electrode 210 includes the positive electrode current collector 211 and positive electrode active material layers 212. In the positive electrode 210, the positive electrode current collector 211 is laminated between the positive electrode active material layers 212. However, the positive electrode active material layer 212 may be provided only on one surface of the positive electrode current collector 211 on the side where the positive electrode 210 faces the negative electrode 220.

The positive electrode current collector 211 contains aluminum, and for example, an aluminum foil can be used. The surface state of the positive electrode current collector 211 will be described later.

The positive electrode active material layer 212 is a layer containing a positive electrode active material capable of occluding and releasing lithium. The positive electrode active material layer 212 contains a positive active material, a lithium carbonate (Li₂CO₃), and a lithium hydroxide (LiOH). The positive electrode active material layer 212 is not limited to the materials cited above, and may further contain, for example, a binder, a conductive agent, and a dispersant.

The positive electrode active material is preferably a lithium-containing compound such as a lithium-containing composite oxide and a lithium-containing phosphate compound. The lithium-containing composite oxide is an oxide containing lithium and one or more elements other than lithium as constituent elements. The lithium-containing composite oxide has, for example, a layered rock-salt-type or spinel-type crystal structure. The lithium-containing phosphate compound is a phosphate compound containing lithium and one or more elements other than lithium as constituent elements. The lithium-containing phosphate compound has, for example, an olivine-type crystal structure. Specific examples of the lithium-containing composite oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13}) O₂, and LiMn₂O₄. Specific examples of the lithium-containing phosphate compound include LiFePO₄, LiMnPO₄, LiFe_{0.5}Mn_{0.5}PO₄, and LiFe_{0.3}Mn_{0.7}PO₄. In this regard, the presence of the lithium-containing composite oxide and the lithium-containing phosphate compound can be determined by analysis with the use of various elemental analysis methods. The elemental analysis method includes any one of or two or more of analysis methods such as an X-ray diffraction (XRD: X-ray Diffraction), high-frequency inductively coupled plasma (ICP: Inductively Coupled Plasma) emission spectroscopy, and energy dispersive X-ray spectroscopy (EDX: Energy Dispersive X-ray Spectroscopy).

The positive electrode active material is more preferably at least one of a first lithium composite oxide and a second lithium composite oxide. The first lithium composite oxide is a lithium-containing compound represented by the formula (1):

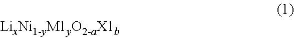

where M1 is at least one of Co, Mn, Mg, Ba, Al, B, Ti, V, Cr, Fe, Cu, Zn, Zr, Mo, Sn, Ca, Sr, W, Na, K, Nb, Ta, and a rare earth element, X1 is at least one of F, Cl, Cr, I, P, S, and Si, and x, y, a, and b satisfy 0.9≤x≤1.1, 0.005≤y≤0.5, −0.1≤a≤0.2, and 0≤b≤0.1,

The second lithium composite oxide is a lithium-containing compound represented by the formula (2):

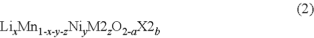

where M2 is at least one of Co, Mg, Ba, Al, B, Ti, V, Cr, Fe, Cu, Zn, Zr, Mo, Sn, Ca, Sr, W, Na, K, Nb, Ta, and a rare earth element, X2 is at least one of F, Cl, Cr, I, P, S, and Si, and x, y, z, a, and b satisfy 0<x≤0.3, 0.3≤y≤0.9, 0≤z≤0.5, −0.1≤a≤0.2, and 0≤b≤0.1.

In this regard, the rare earth element refers to Sc, Y, and lanthanoid.

According to an embodiment, the positive electrode active material layer 212 includes particles of the positive electrode active material. The particle sizes of the particles of the positive electrode active material are not particularly limited, but the particles of the positive electrode active material preferably have D₅₀ of 6 μm or more and 23 μm or less from the viewpoint of ion conductivity. The D₅₀ of the particles of the positive electrode active material is calculated in accordance with, for example, the procedure described below. First, a section of the positive electrode active material layer 212 is observed with the use of a scanning electron microscope (SEM) or the like. The conditions such as an observation range and an observation magnification for the section of the positive electrode active material layer 212 can be arbitrarily set. Subsequently, the longest diameter of the positive electrode active material particles is measured based on the observation result (micrograph) of the section of the positive electrode active material layer 212. Finally, the longest diameter of the positive electrode active material particles at a cumulation of 50% is defined as D₅₀ of the particles of the positive electrode active material. Note that the D₅₀ of the particles of the positive electrode active material may be automatically calculated with the use of image processing software or the like.

The lithium carbonate and the lithium hydroxide are components, which are unintentionally formed in the process of producing the lithium-containing compound described above, thereby remaining in the positive electrode active material layer 212. In the following description, the lithium carbonate and the lithium hydroxide are also collectively and simply referred to as a “residual lithium component”. Containing a large amount of residual lithium component has the possibility of degrading the battery characteristics of the secondary battery.

According to an embodiment, from the viewpoint of ensuring the battery characteristics of the secondary battery, the content (residual amount) of the residual lithium component in the positive electrode active material layer 212 is set in a range in which the amount of the residual lithium component is adequate. Specifically, the content ratio of the lithium carbonate in the positive electrode active material layer 212 is preferably more than 0.05% by mass, more preferably 0.1% by mass or more. In addition, the content ratio of the lithium hydroxide in the positive electrode active material layer 212 is preferably more than 0.05% by mass, more preferably 0.18 by mass or more. Thus, the interface state between the positive electrode current collector 211 and the positive electrode active material layer 212 can be stabilized, and in particular, when the secondary battery is also used (charged/discharged) or stored in a severe environment such as a high-temperature environment or a low-temperature environment, high charge-discharge characteristics are obtained.

According to an embodiment, from the viewpoint of ensuring the battery characteristics of the secondary battery, the content (residual amount) of the residual lithium component is set in a range in which the amount of the residual lithium component is not excessive. The content ratio of the lithium carbonate in the positive electrode active material layer 212 is preferably less than 1.0% by mass, more preferably 0.7% by mass or less. In addition, the content ratio of the lithium hydroxide in the positive electrode active material layer 212 is preferably less than 1.0% by mass, more preferably 0.7% by mass or less. Thus, the surface state of the positive electrode active material, that is, the element distribution at the surface of the lithium-containing compound can be optimized. Specifically, at the surfaces of the lithium-containing compound particles, the content ratio of the constituent elements of the lithium-containing compound can be sufficiently increased with respect to the content ratio of the constituent elements of the residual lithium component. Thus, promoting insertion and extraction of lithium ions into and from the lithium-containing compound while suppressing gas generation caused by the presence of the residual lithium component makes the electrolytic solution less likely to be decomposed on the surfaces of the lithium-containing compound particles. Thus, in particular, when the secondary battery is also used (charged/discharged) or stored in a severe environment such as a high-temperature environment or a low-temperature environment, the above-mentioned advantages can be achieved stably.

The content ratio of the residual lithium component can be measured by using a Warder method in accordance with the procedure described below. First, a predetermined amount m (g) of the positive electrode active material is weighed, and then, the positive electrode active material is placed in a sample bottle. In this case, m=10 (g). Subsequently, 50 mL (=50 cm³) of ultrapure water is put into the sample bottle together with a stirring bar, and then the ultrapure water is stirred for 1 hour with the use of a stirrer. Subsequently, the ultrapure water after the stirring is left to stand for 1 hour, a supernatant liquid of the ultrapure water solution is collected by using a syringe with a filter, and then the supernatant is filtered. Subsequently, 10 mL (=10 cm³) of the filtered supernatant liquid is collected with the use of a whole pipette, and then, the filtered supernatant liquid is placed in a flask with a stopper. Subsequently, after adding one drop of a phenolphthalein solution to the supernatant liquid placed in the flask, the supernatant liquid is subjected to titration with the use of a hydrochloric acid (HCL) that has a concentration c as a titration solution while stirring the supernatant liquid with the use of a stirrer. In this regard, the amount of the hydrochloric acid added dropwise Vₐ (mL) (=Vₐ (cm³)) is read assuming that the end point of the first titration is reached when the liquid color of red disappears. In this regard, the concentration c can be, for example, 0.02 mol/L (=0.02 mol/dm³). Subsequently, after adding two drops of a bromophenol blue solution to the supernatant liquid, the supernatant liquid is further subjected to titration with the use of the titration solution mentioned above while stirring the supernatant liquid with the use of a stirrer. In this regard, the amount of the hydrochloric acid added dropwise V_{b} (mL) (=V_{b} (cm³)) is read assuming that the end point of the second titration is reached when the liquid color of blue disappears and changes to yellowish green. In this regard, an automatic titrator COM-1600 manufactured by Hiranuma Sangyo Co., Ltd. can be used as a titrator. Finally, the content ratio (% by mass) of the lithium carbonate is calculated by using the following formula (3), and the content (% by mass) of the lithium hydroxide is calculated by using the following formula (4).

$$( content ratio of lithium carbonate ( \% by mass ) ) = [ \text{} ( c \times 2 {V}_{b} \times ( f / 1000 ) \times 0.5 \times 73.892 \times 5 ) / m ] \times 100 \qquad ( 3 )$$

$$( content ratio of lithium hydroxide ( \% by mass ) ) = [ \text{} ( c \times ( {V}_{a} - {V}_{b} ) \times ( f / 1000 ) \times 23.941 \times 5 ) / m ] \times 100 \qquad ( 4 )$$

(In the formulae (3) and (4), m is the mass (g) of the positive electrode active material, Vₐ is the amount of dropwise addition (mL (=cm³)) to the end point of the first titration with the phenolphthalein solution, V_{b} is the amount of dropwise addition (mL (=cm³)) from the end point of the first titration with the phenolphthalein solution to the end point of the second titration with the bromophenol blue solution, f is a factor depending on the concentration of the titration solution, and c is the concentration of the titration solution (mol/L (=mol/dm³)).)

The binder (positive electrode binder) contained in the positive electrode active material layer 212, which may be an arbitrary material, contains, for example, one or more of synthetic rubbers and polymer compounds. Examples of the synthetic rubbers include a styrene-butadiene-based rubber, a fluorine-based rubber, and ethylene propylene diene. Examples of the polymer compounds include a polyvinylidene fluoride (PVdF) and a polyimide.

The conductive agent (positive electrode conductive agent) contained in the positive electrode active material layer 212, which may be an arbitrary material, contains, for example, carbon. Examples of the carbon include graphite, carbon black, acetylene black, and ketjen black. The conductive agent contained in the positive electrode active material layer 212 is, however, not limited to these examples as long as the conductive agent is a material with conductivity, and may be a metal material, a conductive polymer, or the like.

The negative electrode 220 includes the negative electrode current collector 221 and negative electrode active material layers 222. In the negative electrode 220, the negative electrode current collector 221 is laminated between the negative electrode active material layers 222. However, the negative electrode active material layer 222 may be provided only on one surface of the negative electrode current collector 221 on the side where the negative electrode 220 faces the positive electrode 210.

The negative electrode current collector 221 is a conductor, and for example, a copper foil or the like can be used.

The negative electrode active material layer 222 is a layer containing a negative electrode active material capable of occluding and releasing lithium. The negative electrode active material layer 222 is not limited to being made of only the negative electrode active material, and may contain, for example, a conductive agent and a binder.

The negative electrode active material preferably contains at least one of a carbon material and a metal-based material. Thus, a high energy density is achieved. Specific examples of the carbon material for use as the negative electrode active material include graphitizable carbon, non-graphitizable carbon, natural graphite, and artificial graphite. The metal-based material for use as the negative electrode active material is a material containing any one or more of metal elements and metalloid elements capable of forming alloys with lithium as constituent elements. Specific examples of the metal elements and the metalloid elements for use as the negative electrode active material include silicon and tin. The metal-based material for use as the negative electrode active material may be a simple substance, an alloy, a compound, a mixture of two or more materials, or a material including two or more phases. Specific examples of the metal-based material for use as the negative electrode active material include TiSi₂ and SiOₓ (0<x≤2).

Further, the negative electrode active material layer 222 is not limited to containing only the negative electrode active material.

For example, the negative electrode active material layer 222 may further contain a negative electrode binder. The negative electrode binder contains at least one of synthetic rubbers, polymer compounds, and the like. Specific examples of the synthetic rubbers for use as the negative electrode binder include a styrene-butadiene-based rubber, fluorine-based rubber, and ethylene propylene diene. Specific examples of the polymer compounds for use as the negative electrode binder include a polyvinylidene fluoride, a polyimide, and a carboxymethyl cellulose.

For example, the negative electrode active material layer 222 may further contain a negative electrode conductive agent. The negative electrode conductive agent contains at least one of a carbon material, a metal material, and a conductive polymer compound. Specific examples of the carbon material for use as the negative electrode conductive agent include particulate carbon materials such as carbon black, acetylene black, and ketjen black, and fibrous carbon materials such as carbon nanotubes. The carbon nanotube is, for example, a single wall carbon nanotube (SWCNT). Thus, the electron conductivity of the particle surface of the negative electrode active material can be improved. The mass ratio of the negative electrode conductive agent to the negative electrode active material layer 222 is preferably 5% or less, more preferably 2% or less. Thus, the paintability of a negative electrode slurry can be improved.

The separator 230 is a membrane that insulates the positive electrode 210 from the negative electrode 220. The separator 230 is provided between a main surface of the positive electrode 210 and a main surface of the negative electrode 220 so as to keep the positive electrode 210 and the negative electrode 220 from coming into direct contact with each other.

Preferably, the material of the separator 230 is electrically stable, is chemically stable against the positive electrode active material, the negative electrode active material, and the electrolytic solution, and has an insulating property. For the separator 230, a layer made of a polymer nonwoven fabric, a porous film, glass, or ceramic fibers can be used, for example. The material of the separator 230 more preferably includes a porous polyolefin film. Thus, the safety of the battery can be improved by the effect of short circuit prevention and the effect of shutdown.

Each of the positive electrode 210, the negative electrode 220, and the separator 230 is impregnated with the electrolytic solution. In the example of FIG. 1, the space inside the exterior film 10 is filled with the electrolytic solution. The electrolytic solution is a non-aqueous electrolytic solution containing an electrolyte salt and a non-aqueous solvent in which the electrolyte salt is dissolved.

The electrolyte salt contains a salt of a bis(fluorosulfonyl)imide such as a lithium bis(fluorosulfonyl)imide (LiFSI, LiN(SO₂F₂)₂). Thus, the charge-discharge characteristics can be improved. Further, the electrolyte salt may contain another electrolyte salt for use as an electrolyte salt of a lithium ion battery. For example, the other electrolyte salt is a light metal salt such as a lithium salt. Specific examples of the lithium salt are preferably lithium salts containing phosphorus (P) such as a lithium hexafluorophosphate (LiPF₆), a lithium monofluorophosphate (Li₂PFO₃), and a lithium difluorophosphate (LiPF₂O₂), and lithium salts containing boron (B) such as a lithium tetrafluoroborate (LiBF₄), and a lithium bis(oxalato) borate (LiB(C₂O₄)₂). Thus, P or B can be contained in the surface of the positive electrode current collector 211. Further, the other electrolyte salt is not limited to the above-mentioned examples, and may be a lithium trifluoromethanesulfonate (LiCF₃SO₃), a lithium bis(trifluoromethanesulfonyl)imide (LiN(CF₃SO₂)₂), a lithium tris(trifluoromethanesulfonyl)methide (LiC(CF₃SO₂)₃), or the like.

The content ratio of the lithium bis(fluorosulfonyl)imide in the electrolytic solution is preferably 1.0 mol/kg or more and 3.0 mol/kg or less. Thus, the charge-discharge characteristics can be kept from being degraded.

The solvent contains at least one selected from the first group consisting of an ethylene carbonate (EC), a propylene carbonate (PC), a fluoroethylene carbonate (FEC), a dimethyl carbonate (DMC), and a gamma butyrolactone (GBL).

The solvent may further contain at least one of carbonic acid esters excluding the compounds included in the first group and chain carboxylic acid esters. Examples of the carbonic acid esters excluding the compounds included in the first group include a diethyl carbonate (DEC) and an ethyl methyl carbonate (EMC). Examples of the chain carboxylic acid esters include a propyl propionate (PrPr), an ethyl propionate (PrEt), a methyl propionate, a propyl acetate (AcPr), an ethyl acetate (AcEt), and a methyl acetate (AcMe).

The solvent may further contain another non-aqueous solvent for use as a non-aqueous solvent of a lithium ion battery. Examples of the other non-aqueous solvent include ethers such as 1,2-dimethoxyethane, tetrahydrofuran, 1,3-dioxolane, and 1,4-dioxane. The ethers may be compounds in which some or all of hydrogen atoms are substituted with fluorine, such as 1,1,2-tetrafluoroethyl 2, 2,2,3,3-tetrafluoropropyl ether.

The electrolytic solution may contain a substance other than the electrolyte salt and the solvent, such as an additive.

The electrolytic solution may further contain, as an additive, at least one of an unsaturated cyclic carbonic acid ester, a fluorinated cyclic carbonic acid ester, a dicarboxylic acid anhydride, a disulfonic acid anhydride, a sulfuric acid ester, a nitrile compound, and an isocyanate compound. Specific examples of the unsaturated cyclic carbonic acid ester include a vinylene carbonate (VC), a methylene ethylene carbonate (MEC), and a vinyl ethylene carbonate (VEC). Specific examples of the fluorinated cyclic carbonic acid ester include a monofluoro ethylene carbonate (FEC) and a difluoro ethylene carbonate (DFEC). Specific examples of the sulfonic acid ester include a propane sultone (PS) and propene sultone (PRS). Specific examples of the dicarboxylic acid anhydride include a succinic acid anhydride (SA) and a 1,2-ethanedisulfonic acid anhydride. Specific examples of the disulfonic acid anhydride include a cyclodisone (CD) and a 2-sulfobenzoic acid anhydride. Specific examples of the sulfuric acid ester include an ethylene sulfate (DTD) and a propanedisulfonic acid anhydride (PSAH). Specific examples of the nitrile compound include a succinonitrile (SN). Specific examples of the isocyanate compound include a hexamethylene diisocyanate (HMI).

In addition, the electrolytic solution may further contain at least one of a lithium hexafluorophosphate (LiPF₆), a lithium tetrafluoroborate (LiBF₄), a lithium bis(oxalato) borate (LiBOB), and a lithium difluorophosphate (LiPF₂O₂) as an additive.

Hereinafter, the surface state of the positive electrode current collector 211 will be described in detail. In the following description, X-ray photoelectron spectroscopy analysis will be described as XPS (X-ray Photoelectron Spectroscopy). In addition, in the following description, the wide scan and the various narrow scans for the surface of the positive electrode current collector 211 refer to XPS under the conditions shown in Table 1, performed for the surface of the positive electrode current collector 211 taken out by disassembling the secondary battery 1. In the wide scan and various narrow scans for the surface of the positive electrode current collector 211, the measurements are preferably more than one time at the measurement frequencies shown in Table 1 to obtain an averaged spectrum.

TABLE 1

| | | Measurement | | | | |
|---|---|---|---|---|---|---|
| | | Energy Range | | | | |
| | | Lower | Upper | Step | Measurement | |
| | Pass Energy | Limit | Limit | Interval | Time per | Measurement |
| | (eV) | (eV) | (eV) | (eV) | Step (ms) | Frequency |
| Wide Scan | 117.4 | 0 | 1100 | 1 | 50 | 10 |
| F1s Narrow Scan | 29.35 | 679 | 697 | 0.10 | 50 | 20 |
| S2p Narrow Scan | 29.35 | 160 | 180 | 0.10 | 50 | 20 |
| Al2p Narrow Scan | 29.35 | 61 | 84 | 0.10 | 50 | 20 |
| P2p Narrow Scan | 29.35 | 127 | 147 | 0.10 | 50 | 20 |
| B1s Narrow Scan | 29.35 | 183 | 203 | 0.10 | 50 | 20 |

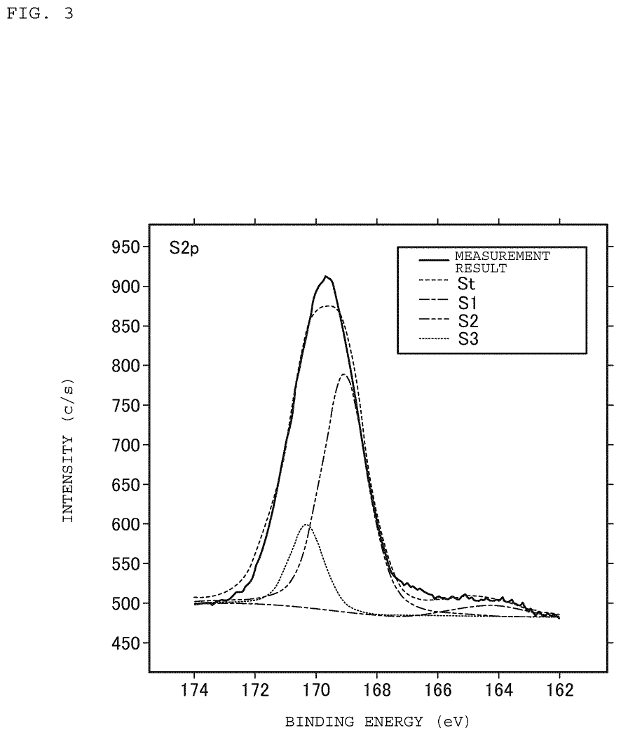

FIG. 3 is a diagram showing an S2p spectrum of XPS for the surface of the positive electrode current collector according to an embodiment. The surface of the positive electrode current collector 211 contains sulfur. In this regard, whether the surface of the positive electrode current collector 211 contains sulfur or not can be determined by whether a peak of the S2p spectrum is detected in the wide scan or S2p narrow scan for the surface of the positive electrode current collector 211. If a peak is detected as shown in FIG. 3, the surface of the positive electrode current collector 211 is considered to contain sulfur. In the present disclosure, the S2p spectrum refers to a spectral range of 160 eV or more and 180 eV or less.

As shown in FIG. 3, the photoelectron spectrum obtained in the XPS for the surface of the positive electrode current collector 211 has a first signal S1 with a peak in a range of 164.1 eV or more and 164.5 eV or less and a second signal S2 with a peak at 168.9 eV or more and 169.3 eV or less. The presence or absence of the first signal S1 and second signal S2 can be determined by performing peak separation with the use of a Gaussian/Lorentz mixing function for the S2p spectrum obtained in the S2p narrow scan for the surface of the positive electrode current collector 211.

The ratio (I_{S1}+I_{S2})/I_{St} of the sum of the signal intensity I_{S1} of the first signal S1 and the signal intensity I_{S2} of the second signal S2 to the sum total I_{St} of the signal intensities of the S2p spectrum is 0.97 or less. Thus, charging and discharging can be performed favorably. The signal intensity I_{S1} of the first signal S1 and the signal intensity I_{S2} of the second signal S2 refer to the differences between the base line and the respective peak tops of the first signal S1 and second signal S2. In addition, the sum total I_{St} of the signal intensities of the S2p spectrum refers to the difference between the base line and the peak top of the synthesized signal St obtained by synthesizing the respective signals S1 to S3 obtained by the peak separation of the S2p spectrum.

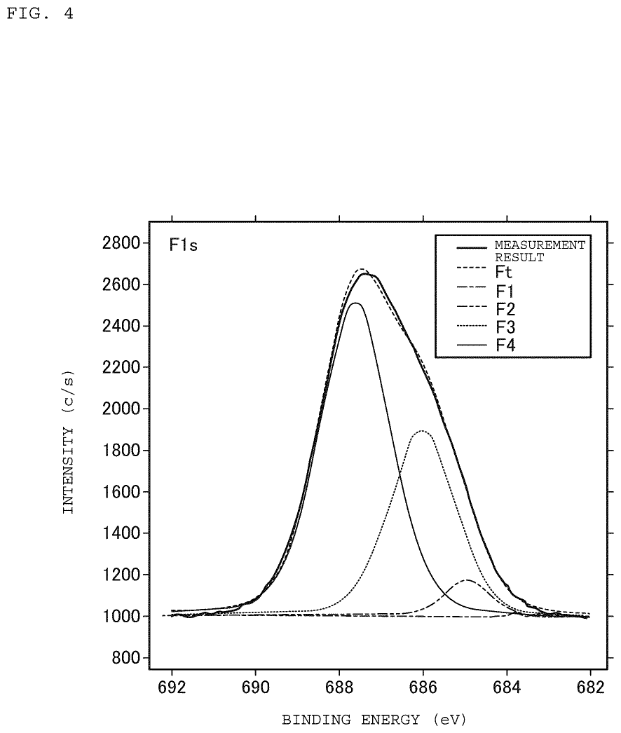

FIG. 4 is a diagram showing an F1s spectrum of XPS for the surface of the positive electrode current collector according to an embodiment. The surface of the positive electrode current collector 211 preferably further contains fluorine. In this regard, whether the surface of the positive electrode current collector 211 contains fluorine or not can be determined by whether a peak of the F1s spectrum is detected in the wide scan or F1s narrow scan for the surface of the positive electrode current collector 211. If a peak is detected as shown in FIG. 4, the surface of the positive electrode current collector 211 is considered to contain fluorine. In the present disclosure, the F1s spectrum refers to a range of 679 eV or more and 697 eV or less.

As shown in FIG. 4, the photoelectron spectrum obtained by the XPS for the surface of the positive electrode current collector 211 has a third signal F1 with a peak at 685.7 eV or more and 686.1 eV or less and a fourth signal F2 with a peak at 687.4 eV or more and 687.8 eV or less. The presence or absence of the third signal F1 and fourth signal F2 can be determined by performing peak separation with the use of a Gaussian/Lorentz mixing function for the F1s spectrum obtained in the F1s narrow scan for the surface of the positive electrode current collector 211.

The ratio (I_{F1}+I_{F2})/I_{Ft} of the sum of the signal intensity I_{F1} of the third signal F1 and the signal intensity I_{F2} of the fourth signal F2 to the sum total I_{Ft} of the signal intensities of the F1s spectrum is 0.80 or more. The signal intensity I_{F1} of the third signal F1 and the signal intensity I_{F2} of the fourth signal F2 refer to the differences between the base line and the respective peak tops of the third signal F1 and fourth signal F2. In addition, the sum total I_{Ft} of the signal intensities of the F1s spectrum refers to the difference between the base line and the peak top of the synthesized signal Ft obtained by synthesizing the respective signals F1 to F4 obtained by the peak separation of the F1s spectrum.

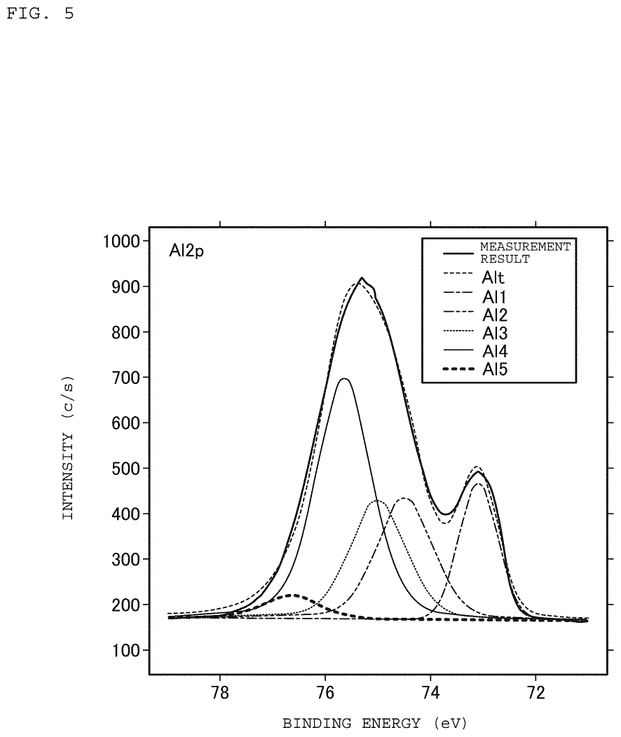

FIG. 5 is a diagram showing an Al2p spectrum of XPS for the surface of the positive electrode current collector according to an embodiment. The surface of the positive electrode current collector 211 more preferably further contains aluminum. In this regard, the fact that the surface of the positive electrode current collector 211 contains aluminum can be determined by detecting a peak of the Al2p spectrum as shown in FIG. 5 in the wide scan or Al2p narrow scan for the surface of the positive electrode current collector 211. In the present disclosure, the Al2p spectrum refers to a range of 61 eV or more and 84 eV or less.

As shown in FIG. 5, the photoelectron spectrum obtained in the XPS for the surface of the positive electrode current collector 211 has a fifth signal Al1 with a peak at 75.4 eV or more and 75.8 eV or less and a sixth signal Al2 with a peak at 76.4 eV or more and 76.8 eV or less. The presence or absence of the fifth signal Al1 and sixth signal Al2 can be determined by performing peak separation with the use of a Gaussian/Lorentz mixing function for the Al2p spectrum obtained in the Al2p narrow scan for the surface of the positive electrode current collector 211.

The ratio (I_{Al1}+I_{Al2})/I_{Alt} of the sum of the signal intensity I_{Al1} of the fifth signal Al1 and the signal intensity I_{Al2} of the sixth signal Al2 to the sum total I_{Alt} of the signal intensities of the Al2p spectrum is 0.30 or more. Thus, the charge-discharge characteristics can be improved. The signal intensity I_{Al1} of the fifth signal Al1 and the signal intensity I_{Al2} of the sixth signal Al2 refer to the differences between the base line and the respective peak tops of the fifth signal Al1 and sixth signal Al2. In addition, the sum total I_{Alt} of the signal intensities of the Al2p spectrum refers to the difference between the base line and the peak top of the synthesized signal Alt obtained by synthesizing the respective signals Al1 to Al5 obtained by the peak separation of the Al2p spectrum.

The surface of the positive electrode current collector 211 further preferably further contains at least one of boron and phosphorus. As a result, charge-discharge characteristics can be improved. In this regard, the fact that the surface of the positive electrode current collector 211 contains boron can be determined by detecting a peak of a Bls spectrum in the wide scan or Bls narrow scan for the surface of the positive electrode current collector 211. In the present disclosure, the Bls spectrum refers to a range of 183 eV or more and 203 eV or less. In addition, the fact that the surface of the positive electrode current collector 211 contains phosphorus can be determined by detecting a peak of a P2p spectrum in the wide scan or P2p narrow scan for the surface of the positive electrode current collector 211. In the present disclosure, the P2p spectrum refers to a range of 127 eV or more and 147 eV or less.

As described above, the secondary battery 1 according to an embodiment is a secondary battery including the positive electrode 210, the negative electrode 220, and the electrolytic solution. The positive electrode 210 includes the positive electrode current collector 211 containing aluminum and the positive electrode active material layer 212 provided on the positive electrode current collector 211. The positive electrode active material layer contains a lithium-containing compound, a lithium carbonate, and a lithium hydroxide. The non-aqueous electrolytic solution contains an electrolyte salt and an organic solvent. The electrolyte contains a bis(fluorosulfonyl)imide salt. The surface of the positive electrode current collector 211 contains sulfur. The photoelectron spectrum obtained in X-ray photoelectron spectroscopy for the surface of the positive electrode current collector 211 has a first signal S1 with a peak in a range of 164.1 eV or more and 164.5 eV or less and a second signal S2 with a peak in a range of 168.9 eV or more and 169.3 eV or less. The ratio (I_{S1}+I_{S2})/I_{St} of the sum of the signal intensity I_{S1} of the first signal S1 and the signal intensity I_{S2} of the second signal S2 to the sum total I_{St} of the signal intensities of the S2p spectrum is 0.97 or less. Thus, the charge-discharge characteristics can be improved.

In an embodiment, the surface of the positive electrode current collector 211 contains fluorine. The photoelectron spectrum obtained in the X-ray photoelectron spectroscopy for the surface of the positive electrode current collector 211 has a third signal F1 with a peak at 685.7 eV or more and 686.1 eV or less and a fourth signal F2 with a peak at 687.4 eV or more and 687.8 eV or less. The ratio (I_{F1}+I_{F2})/I_{Ft} of the sum of the signal intensity Im of the third signal F1 and the signal intensity I_{F2} of the fourth signal F2 to the sum total I_{Ft} of the signal intensities of the F1s spectrum is 0.80 or more. As a result, charge-discharge characteristics can be improved.

In an embodiment, the surface of the positive electrode current collector 211 contains aluminum. The photoelectron spectrum obtained in the X-ray photoelectron spectroscopy for the surface of the positive electrode current collector 211 has a fifth signal Al1 with a peak at 75.4 eV or more and 75.8 eV or less and a sixth signal Al2 with a peak at 76.4 eV or more and 76.8 eV or less. The ratio (I_{Al1}+I_{Al2})/I_{Alt} of the sum of the signal intensity I_{Al1} of the fifth signal Al1 and the signal intensity I_{Al2} of the sixth signal Al2 to the sum total I_{Alt} of the signal intensities of the Al2p spectrum is 0.30 or more. As a result, charge-discharge characteristics can be improved.

In an embodiment, the surface of the positive electrode current collector 211 contains at least one of boron and phosphorus. As a result, the charge-discharge characteristics can be further improved.

In an embodiment, the content ratio of a lithium carbonate in the positive electrode active material layer 212 is more than 0.05% by mass and less than 1.0% by mass. Thus, while stabilizing the interface state between the positive electrode active material layer and the positive electrode current collector layer, the electrolytic solution is made less likely to be decomposed on the surfaces of lithium-containing compound particles, and in particular, the charge-discharge characteristics in a severe environment such as a high-temperature environment or a low-temperature environment can be improved.

In an embodiment, the content ratio of a lithium hydroxide in the positive electrode active material layer 212 is more than 0.05% by mass and less than 1.0% by mass. Thus, while stabilizing the interface state between the positive electrode active material layer and the positive electrode current collector layer, the electrolytic solution is made less likely to be decomposed on the surfaces of lithium-containing compound particles, and in particular, the charge-discharge characteristics in a severe environment such as a high-temperature environment or a low-temperature environment can be improved.

In an embodiment, the lithium-containing compound contains at least one of a first lithium composite oxide represented by the formula (1) and a second lithium composite oxide represented by the formula (2). Thus, the voltage of the secondary battery 1 can be improved, and thus, the charge-discharge characteristics can be further improved.

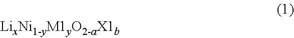

where M1 is at least one of Co, Mn, Mg, Ba, Al, B, Ti, V, Cr, Fe, Cu, Zn, Zr, Mo, Sn, Ca, Sr, W, Na, K, Nb, Ta, and a rare earth element, X1 is at least one of F, Cl, Cr, I, P, S, and Si, and x, y, a, and b satisfy 0.9≤x≤1.1, 0.005≤y≤0.5, −0.1≤a≤0.2, and 0≤b≤0.1.

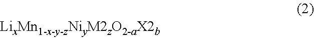

where M2 is at least one of Co, Mg, Ba, Al, B, Ti, V, Cr, Fe, Cu, Zn, Zr, Mo, Sn, Ca, Sr, W, Na, K, Nb, Ta, and a rare earth element, X2 is at least one of F, Cl, Cr, I, P, S, and Si, and x, y, z, a, and b satisfy 0<x≤0.3, 0.3≤y≤0.9, 0≤z≤0.5, −0.1≤a≤0.2, and 0≤b≤0.1.

In an embodiment, the electrolytic solution contains light metal ions as cations. Also in this case, the charge-discharge characteristics can be improved. Thus, the voltage of the secondary battery 1 can be improved, and thus, the charge-discharge characteristics can be improved.

In an embodiment, the light metal ions include lithium ions. Thus, the voltage of the secondary battery 1 can be further improved, and thus, the charge-discharge characteristics can be further improved.

In an embodiment, the content ratio of a lithium bis(fluorosulfonyl)imide in the electrolytic solution is preferably 1.0 mol/kg or more and 3.0 mol/kg or less. Thus, the ion conductivity of the electrolytic solution can be improved, and the charge-discharge characteristics can be further improved.

In an embodiment, the electrolytic solution more preferably further contains at least one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, and an isocyanate compound. Thus, the decomposition reaction of the electrolytic solution can be inhibited, and thus, the charge-discharge characteristics can be further improved.

In an embodiment, the electrolytic solution further contains at least one of a lithium hexafluorophosphate, a lithium tetrafluoroborate, a lithium bis(oxalato) borate, and a lithium difluorophosphate. Thus, the moving speed of lithium ions is further improved, and thus, the charge-discharge characteristics can be further improved.

In an embodiment, the secondary battery according to an embodiment is a lithium ion secondary battery. Thus, occlusion and release of lithium are utilized to obtain a sufficient battery capacity in a stable manner, and thus, the charge-discharge characteristics can be further improved.

Now, an example of a method for manufacturing the secondary battery 1 according to an embodiment will be described below. The method for manufacturing the secondary battery 1 according to an embodiment includes a step of preparing the positive electrode 210, a step of preparing the negative electrode 220, a step of preparing the electrolytic solution, a step of assembling a laminate cell, and a charge-discharge step.

In the step of preparing the positive electrode 210, the positive electrode 210 is prepared by applying, to the positive electrode current collector 211, a positive electrode mixture slurry in which a positive electrode mixture is dispersed, followed by drying and compression forming. The positive electrode mixture is prepared by mixing a positive electrode active material, a positive electrode binder, and a positive electrode conductive agent. Then, the prepared positive electrode mixture is dispersed in a dispersion liquid such as N-methyl-2-pyrrolidone (NMP) to prepare a positive electrode mixture slurry, and then, the prepared positive electrode mixture slurry is uniformly applied to both surfaces of the positive electrode current collector 211. The applied material obtained is dried with hot air or the like, and then subjected to compression molding with a roll press machine or the like to prepare the positive electrode 210. The positive electrode lead 31 is attached to the prepared positive electrode 210 at a part where the positive electrode current collector 211 is exposed.

In the step of preparing the negative electrode 220, the negative electrode 220 is prepared by applying, to the negative electrode current collector 221, a negative electrode mixture slurry in which a negative electrode mixture is dispersed, followed by drying and compression forming. The negative electrode mixture is prepared by mixing a negative electrode active material and a negative electrode binder. The prepared negative electrode mixture is dispersed in a dispersion liquid such as NMP to prepare a negative electrode mixture slurry, and then, the negative electrode mixture is uniformly applied to both surfaces of the negative electrode current collector. The applied material obtained is dried with hot air or the like, and then subjected to compression molding with a roll press machine or the like to prepare the negative electrode 220. The negative electrode lead 32 is attached to the prepared negative electrode 220 at a part where the negative electrode current collector 221 is exposed.

In the step of preparing an electrolytic solution, an electrolytic solution is prepared by dissolving an electrolyte salt in a solvent.

In the step of assembling the laminate cell, the laminate cell is assembled by preparing an electrode body, then placing the electrode body in an exterior member, and injecting the electrolytic solution to seal the exterior member. The positive electrode 210, the separator 230, and the negative electrode 220 are stacked in this order, and then wound in the longitudinal direction to prepare an electrode body. The prepared electrode body is placed in an exterior member, and three sides of the exterior member are thermally fused, such that the other one side is provided with an opening without being thermally fused. Thereafter, the electrolytic solution is injected from the opening of the exterior member, and the remaining one side of the exterior member is thermally fused in a reduced pressure environment to seal the exterior member, thereby forming a laminate cell.

In the charge-discharge step, the prepared laminate cell is charged and discharged for one cycle. In this regard, the charge-discharge for one cycle can be performed, for example, under a charge-discharge condition A, B, or C. The charge-discharge condition A is a condition under which first charging, first leaving to stand, second charging, second leaving to stand, and discharging are sequentially performed at a temperature of 33° C. under the following conditions.
First charging method: CCCV
First charging rate: 0.2 C
First charge control voltage: 3.0 V
First cut-off time: 1 hour
First standing time: 12 hours
Second charging method: CCCV
Second charging rate: 0.2 C
Second charge control voltage: 4.2 V
Second cut-off time: 8 hours
Second standing time: 12 hours
Discharging method: CC
Discharging rate: 0.2 C
End-of-discharge voltage: 2.5 V

The charge-discharge condition B is a condition obtained by changing the second standing time of the charge-discharge condition A to 5 minutes, and changing the temperature at which charge-discharge is performed to 25° C.

The charge-discharge condition C is a condition obtained by changing the second standing time of the charge-discharge condition A to 72 hours, and changing the temperature at which charge-discharge is performed to 25° C.

Performing charge-discharge under the charge-discharge condition such as the charge-discharge condition A, B, or C described above allows a good film to be formed on the positive electrode current collector 211, and allows the secondary battery 1 to be made electrochemically stable.

The secondary battery 1 according to an embodiment can be manufactured as described above. The above-described method for manufacturing the secondary battery is an example, and the present disclosure is not limited thereto.

### EXAMPLES

Examples will be described below according to an embodiment. Note that the present disclosure is not limited by the following examples.

Table 2 is a table showing Example 1-1 to Example 1-39 and Comparative Example 1-1 to Comparative Example 1-3.

TABLE 2

| | Positive Electrode | | | | | | | |
|---|---|---|---|---|---|---|---|---|
| | Positive | | | | | | | |
| | Electrode | | | | Electrolytic Solution | | | |
| | Active | | | | Electrolyte | | | |
| | Material | | Li₂CO₃ | LiOH | Salt | | Solvent | Charge- |
| | | D₅₀ | (% by | (% by | (mol/kg) | | (mass | discharge |
| | Type | (μm) | mass) | mass) | LiFSI | LiPF₆ | ratio) | Condition |
| Example 1-1 | LNCA | 12 | 0.2 | 0.2 | 2.00 | — | EC:PrPr = 53:47 | A |
| Comparative | LNCA | 12 | 0.2 | 0.2 | 2.00 | — | EC:PrPr = 53:47 | D |
| Example 1-1 | | | | | | | | |
| Example 1-2 | LNCA | 12 | 0.2 | 0.2 | 2.00 | — | EC:PrPr = 53:47 | B |
| Example 1-3 | LNCA | 12 | 0.2 | 0.2 | 2.00 | — | EC:PrPr = 53:47 | C |
| Comparative | LNCA | 12 | 0.2 | 0.2 | 2.00 | — | EC:PrPr = 53:47 | E |
| Example 1-2 | | | | | | | | |
| Comparative | LNCA | 12 | 0.2 | 0.2 | 2.00 | — | EC:GBL = 30:70 | E |
| Example 1-3 | | | | | | | | |
| Example 1-4 | LNCA | 12 | 0.2 | 0.2 | 2.00 | — | EC:PrPr = 34:66 | A |
| Example 1-5 | LNCA | 12 | 0.2 | 0.2 | 2.10 | — | EC:PrEt = 37:63 | A |
| Example 1-6 | LNCA | 12 | 0.2 | 0.2 | 2.10 | — | EC:AcPr = 37:63 | A |
| Example 1-7 | LNCA | 12 | 0.2 | 0.2 | 2.20 | — | EC:PrEt = 18:82 | A |
| Example 1-8 | LNCA | 12 | 0.2 | 0.2 | 2.20 | — | EC:AcPr = 18:82 | A |
| Example 1-9 | LNCA | 12 | 0.2 | 0.2 | 2.20 | — | EC:AcMe = 18:82 | A |
| Example 1-10 | LNCA | 12 | 0.2 | 0.2 | 2.20 | — | EC:AcEt = 18:82 | A |
| Example 1-11 | LNCA | 12 | 0.2 | 0.2 | 2.20 | — | EC:PrEt:DMC = 19:24:57 | A |
| Example 1-12 | LNCA | 12 | 0.2 | 0.2 | 2.20 | — | EC:AcPr:DMC = 19:24:57 | A |
| Example 1-13 | LNCA | 12 | 0.2 | 0.2 | 2.20 | — | EC:AcMe:DMC = 19:24:57 | A |
| Example 1-14 | LNCA | 12 | 0.2 | 0.2 | 2.20 | — | EC:AcEt:DMC = 19:24:57 | A |
| Example 1-15 | LNCA | 12 | 0.05 | 0.05 | 2.20 | — | EC:PrPr:DMC = 19:24:57 | A |
| Example 1-16 | LNCA | 12 | 0.1 | 0.1 | 2.20 | — | EC:PrPr:DMC = 19:24:57 | A |
| Example 1-17 | LNCA | 12 | 0.2 | 0.2 | 1.80 | 0.20 | EC:PrPr:DMC = 19:24:57 | A |
| Example 1-18 | LNCA | 12 | 0.2 | 0.2 | 1.60 | 0.40 | EC:PrPr:DMC = 19:24:57 | A |
| Example 1-19 | LNCA | 12 | 0.2 | 0.2 | 1.20 | 0.80 | EC:PrPr:DMC = 19:24:57 | A |
| Example 1-20 | LNCA | 12 | 0.2 | 0.2 | 1.40 | 0.20 | EC:PrPr:DMC = 19:24:57 | A |
| Example 1-21 | LNCA | 12 | 0.2 | 0.2 | 1.20 | 0.40 | EC:PrPr:DMC = 19:24:57 | A |
| Example 1-22 | LNCA | 12 | 0.2 | 0.2 | 1.00 | 0.60 | EC:PrPr:DMC = 19:24:57 | A |
| Example 1-23 | LNCA | 12 | 0.2 | 0.2 | 2.20 | — | EC:PrPr:DMC = 19:24:57 | A |
| Example 1-24 | LNCA | 12 | 0.2 | 0.3 | 2.20 | — | EC:PrPr:DMC = 19:24:57 | A |
| Example 1-25 | LNCA | 12 | 0.2 | 0.5 | 2.20 | — | EC:PrPr:DMC = 19:24:57 | A |
| Example 1-26 | LNCA | 12 | 0.2 | 0.7 | 2.20 | — | EC:PrPr:DMC = 19:24:57 | A |
| Example 1-27 | LNCA | 12 | 0.2 | 1.0 | 2.20 | — | EC:PrPr:DMC = 19:24:57 | A |
| Example 1-28 | LNCA | 12 | 0.3 | 0.2 | 2.20 | — | EC:PrPr:DMC = 19:24:57 | A |
| Example 1-29 | LNCA | 12 | 0.5 | 0.2 | 2.20 | — | EC:PrPr:DMC = 19:24:57 | A |
| Example 1-30 | LNCA | 12 | 0.7 | 0.2 | 2.20 | — | EC:PrPr:DMC = 19:24:57 | A |
| Example 1-31 | LNCA | 12 | 1.0 | 0.2 | 2.20 | — | EC:PrPr:DMC = 19:24:57 | A |
| Example 1-32 | LNCA | 12 | 0.5 | 0.5 | 2.20 | — | EC:PrPr:DMC = 19:24:57 | A |
| Example 1-33 | LNCA | 12 | 0.7 | 0.7 | 2.20 | — | EC:PrPr:DMC = 19:24:57 | A |
| Example 1-34 | LNCA | 6 | 0.2 | 0.2 | 2.20 | — | EC:PrPr:DMC = 19:24:57 | A |
| Example 1-35 | LNCA | 8 | 0.2 | 0.2 | 2.20 | — | EC:PrPr:DMC = 19:24:57 | A |
| Example 1-36 | LNCA | 14 | 0.2 | 0.2 | 2.20 | — | EC:PrPr:DMC = 19:24:57 | A |
| Example 1-37 | LNCA | 16 | 0.2 | 0.2 | 2.20 | — | EC:PrPr:DMC = 19:24:57 | A |
| Example 1-38 | LNCA | 20 | 0.2 | 0.2 | 2.20 | — | EC:PrPr:DMC = 19:24:57 | A |
| Example 1-39 | LNCA | 23 | 0.2 | 0.2 | 2.20 | — | EC:PrPr:DMC = 19:24:57 | A |

| | XPS Measurement | | | | Test Results | | |
|---|---|---|---|---|---|---|---|
| | | | | Presence | | | Low- |
| | | | | or | | Storage | temperature |
| | (I_{S1} + | (I_{F1} + | (I_{A11} + | Absence | Cycle | Retention | Load |
| | I_{S2})/ | I_{F2})/ | I_{A12})/ | of P2p or | Retention | Ratio | Retention |
| | I_{St} | I_{Ft} | I_{Alt} | B1s | Ratio (%) | (%) | Ratio (%) |
| Example 1-1 | 0.97 | 0.78 | 0.30 | N | 33 | 57 | 44 |
| Comparative | 0.99 | 0.76 | 0.26 | N | 0 | 0 | 0 |
| Example 1-1 | | | | | | | |
| Example 1-2 | 0.97 | 0.78 | 0.27 | N | 27 | 40 | 30 |
| Example 1-3 | 0.96 | 0.81 | 0.27 | N | 44 | 51 | 32 |
| Comparative | 0.99 | 0.76 | 0.26 | N | 0 | 0 | 0 |
| Example 1-2 | | | | | | | |
| Comparative | 0.99 | 0.74 | 0.25 | N | 0 | 0 | 0 |
| Example 1-3 | | | | | | | |
| Example 1-4 | 0.84 | 0.90 | 0.35 | N | 82 | 82 | 60 |
| Example 1-5 | 0.93 | 0.83 | 0.34 | N | 80 | 78 | 72 |
| Example 1-6 | 0.86 | 0.88 | 0.35 | N | 84 | 82 | 70 |
| Example 1-7 | 0.90 | 0.85 | 0.38 | N | 88 | 86 | 82 |
| Example 1-8 | 0.91 | 0.85 | 0.37 | N | 87 | 85 | 78 |
| Example 1-9 | 0.93 | 0.82 | 0.37 | N | 84 | 80 | 84 |
| Example 1-10 | 0.93 | 0.82 | 0.33 | N | 82 | 78 | 87 |
| Example 1-11 | 0.92 | 0.84 | 0.34 | N | 90 | 88 | 81 |
| Example 1-12 | 0.93 | 0.84 | 0.34 | N | 88 | 87 | 78 |
| Example 1-13 | 0.94 | 0.83 | 0.36 | N | 86 | 82 | 84 |
| Example 1-14 | 0.94 | 0.84 | 0.36 | N | 86 | 82 | 84 |
| Example 1-15 | 0.94 | 0.84 | 0.36 | N | 88 | 78 | 45 |
| Example 1-16 | 0.94 | 0.84 | 0.36 | N | 88 | 86 | 55 |
| Example 1-17 | 0.82 | 0.92 | 0.62 | Y | 88 | 88 | 62 |
| Example 1-18 | 0.80 | 0.90 | 0.55 | Y | 88 | 89 | 61 |
| Example 1-19 | 0.79 | 0.89 | 0.56 | Y | 87 | 91 | 58 |
| Example 1-20 | 0.85 | 0.93 | 0.60 | Y | 86 | 88 | 66 |
| Example 1-21 | 0.83 | 0.91 | 0.53 | Y | 86 | 89 | 64 |
| Example 1-22 | 0.82 | 0.90 | 0.54 | Y | 85 | 91 | 62 |
| Example 1-23 | 0.90 | 0.85 | 0.35 | N | 88 | 86 | 64 |
| Example 1-24 | 0.90 | 0.85 | 0.35 | N | 86 | 84 | 63 |
| Example 1-25 | 0.90 | 0.85 | 0.35 | N | 84 | 79 | 62 |
| Example 1-26 | 0.90 | 0.85 | 0.35 | N | 80 | 72 | 60 |
| Example 1-27 | 0.90 | 0.85 | 0.35 | N | 68 | 51 | 54 |
| Example 1-28 | 0.90 | 0.85 | 0.35 | N | 86 | 84 | 63 |
| Example 1-29 | 0.90 | 0.85 | 0.35 | N | 85 | 81 | 62 |
| Example 1-30 | 0.90 | 0.85 | 0.35 | N | 78 | 74 | 59 |
| Example 1-31 | 0.90 | 0.85 | 0.35 | N | 66 | 46 | 54 |
| Example 1-32 | 0.90 | 0.85 | 0.35 | N | 84 | 80 | 60 |
| Example 1-33 | 0.90 | 0.85 | 0.35 | N | 78 | 71 | 54 |
| Example 1-34 | 0.90 | 0.85 | 0.35 | N | 88 | 82 | 73 |
| Example 1-35 | 0.90 | 0.85 | 0.35 | N | 90 | 85 | 69 |
| Example 1-36 | 0.90 | 0.85 | 0.35 | N | 90 | 88 | 62 |
| Example 1-37 | 0.90 | 0.85 | 0.35 | N | 88 | 90 | 60 |
| Example 1-38 | 0.90 | 0.85 | 0.35 | N | 88 | 90 | 58 |
| Example 1-39 | 0.90 | 0.85 | 0.35 | N | 88 | 90 | 56 |

In the column of “charge-discharge condition” in the tables shown by Table 2 and subsequent tables, each of “A”, “B”, and “C” indicates that the laminate cell was charged and discharged under each of the charge-discharge conditions A, B, and C described above in the charge-discharge step. In the column of “charge-discharge condition” in Table 2 and the subsequent tables, each of “D” and “E” indicates that the laminate cell was charged and discharged under each of charge-discharge conditions D and E in the charge-discharge step.

In this regard, the charge-discharge condition D is a condition under which charging, leaving to stand, and discharging are sequentially performed at a temperature of 25° C. under the following conditions. More specifically, unlike the charge-discharge conditions A, B, and C under which charging is performed two times, charging is performed one time under the charge-discharge condition D.
Charging method: CCCV
Charging rate: 0.2 C
Charge control voltage: 4.2 V
Cut-off time: 8 hours
Standing time: 5 minutes
Discharging method: CC
Discharging rate: 0.2 C
End-of-discharge voltage: 2.5 V

In this regard, the charge-discharge condition E is a condition under which charging, leaving to stand, and discharging are sequentially performed at a temperature of 25° C. under the following conditions. More specifically, unlike the charge-discharge conditions A, B, and C under which charging is performed two times, charging is performed one time under the charge-discharge condition E.
Charging method: CCCV
Charging rate: 0.1 C
Charge control voltage: 4.2 V
Cutoff current: 0.05 C
Standing time: 5 minutes
Discharging method: CC
Discharging rate: 0.1 C
End-of-discharge voltage: 2.5 V

### Example 1-1

A positive electrode according to Example 1-1 was prepared by applying, to the positive electrode current collector 211, a positive electrode mixture slurry in which a positive electrode mixture was dispersed, followed by drying and compression forming. A first lithium composite oxide (LiNi_{0.82}Co_{0.14}Al_{0.4}O₂, LNCA) powder as a positive electrode active material, a polyvinylidene fluoride (PVdF) as a positive electrode binder, and carbon black as a positive electrode conductive agent were mixed at mass ratios of 91:3:6 to prepare a positive electrode mixture. In this regard, the particle sizes of the positive electrode active material were adjusted to have D₅₀ shown in Table 2. The prepared positive electrode mixture with the particle sizes adjusted was dispersed in N-methyl-2-pyrrolidone (NMP) to prepare a positive electrode mixture slurry, a strip-shaped aluminum foil of 12 μm in thickness was then prepared as a positive electrode current collector, and the prepared positive electrode mixture slurry was uniformly applied to both surfaces of the aluminum foil. The applied material obtained was dried with hot air, and then subjected to compression molding with a roll press machine to prepare a positive electrode. Washing the obtained positive electrode resulted in the values shown in Table 2 for the concentrations of lithium carbonate (Li₂CO₃) and lithium hydroxide (LiOH). A positive electrode lead is attached to the prepared positive electrode at a part where the positive electrode current collector is exposed.

A negative electrode according to Example 1-1 was prepared by applying, to the negative electrode current collector 221, a negative electrode mixture slurry in which a negative electrode mixture was dispersed, followed by drying and compression forming. Artificial graphite as a negative electrode active material and PVdF as a negative electrode binder were mixed at mass ratios of 93:7 to prepare a negative electrode mixture. The prepared negative electrode mixture was dispersed in N-methyl-2-pyrrolidone (NMP) to prepare a negative electrode mixture slurry, a copper foil of 15 μm in thickness was then prepared as a negative electrode current collector, and the negative electrode mixture was uniformly applied to both surfaces of the copper foil. The applied material obtained was dried with hot air, and then subjected to compression molding with a roll press machine to prepare a negative electrode. A negative electrode lead was attached to the prepared negative electrode at a part where the negative electrode current collector is exposed.

For a separator according to Example 1-1, a microporous polyethylene film of 15 μm in thickness was used.

An electrolytic solution according to Example 1-1 was prepared in accordance with the components and proportions shown in Table 2 for a solvent and an electrolyte salt.

A laminate cell according to Example 1-1 was assembled by preparing an electrode body, then placing the electrode body in an exterior member, and injecting the electrolytic solution to seal the exterior member. The electrode body was prepared by stacking the positive electrode and negative electrode prepared as mentioned above with the separator interposed therebetween, then bringing the electrodes and the separator into close contact with each other, and winding the stack in the longitudinal direction. The prepared electrode body was placed in an exterior member, and three sides of the exterior member were thermally fused, such that the other one side was provided with an opening without being thermally fused. For the exterior member, a laminate film was used, which was a laminate of a 25 μm thick nylon film as an outermost layer, a 40 μm thick aluminum foil as a metal layer, and a 30 μm thick polypropylene film as an insulating layer. Thereafter, the electrolytic solution prepared as mentioned above was injected from the opening of the exterior member, and the remaining one side of the exterior member was thermally fused in a reduced pressure environment to seal the exterior member, thereby forming a laminate cell.

For Example 1-1, the prepared laminate cell was charged and discharged under the charge-discharge condition A. Thus, a battery according to Example 1-1 was prepared.

### <<XPS Measurement>>

For Example 1-1, the surface of the positive electrode current collector was subjected to measurement by XPS. In the measurement by XPS, the battery was disassembled in a glove box in an argon atmosphere, and the positive electrode current collector was taken out, and washed with a dimethyl carbonate to prepare a sample. Thereafter, the sample was introduced into an X-ray photoelectron spectrometer (PHI5000 VersaProve, manufactured by ULVAC-PHI, Inc.) without being exposed to the atmosphere, and subjected to a wide scan and various narrow scans under the above-mentioned conditions of Table 1 with a monochromatized Al-Kα ray (1486.6 eV) of about 100 μm in diameter as an X-ray beam for the measurement. In the measurement by XPS, charge neutralization was performed with electron beams and ion beams. The S2p, F1s, A12p, P2p, and Bls spectra obtained respectively by the S2p narrow scan, the F1s narrow scan, the Al2p narrow scan, and the wide scan in accordance with Table 1 above were subjected to peak separation with the use of a Gaussian/Lorentz mixing function to measure the signal intensity ratios (I_{S1}+I_{S2})/I_{St}, (I_{F1}+I_{F2})/I_{Ft}, and (I_{Al1}+I_{Al2})/I_{Alt}, and the presence or absence of P2p spectra. As a result, the values of (I_{S1}+I_{S2})/I_{St}, (I_{F1}+I_{F2})/I_{Ft}, and (I_{Al1}+I_{Al2})/I_{Alt} and the presence or absence of the P2p spectrum were as shown in Table 2. In this regard, in the column of “presence or absence of P2p or Bls” in Table 2 and the subsequent tables, “Y” indicates that a peak was detected from at least one of the P2p spectrum and the Bls spectrum in the wide scan, and “N” indicates that no peak was detected from either the P2p spectrum or the Bls spectrum in the wide scan.

### <<Cycle Characteristics Test>>

For Example 1-1, a cycle characteristics test was performed. In the cycle characteristics test, the secondary battery prepared as mentioned above was charged and discharged for 100 cycles under the following conditions in an environment at 60° C., and the discharge capacity in the 1st cycle and the discharge capacity in the 100th cycle were measured. The ratio of the discharge capacity in the 100th cycle to the discharge capacity in the 1st cycle was calculated as a cycle retention ratio. More specifically, the cycle retention ratio was calculated based on the calculation formula: cycle retention ratio (%)=(discharge capacity in 100th cycle/discharge capacity in 1st cycle)×100.
Charging method: CCCV
Charging rate: 0.1 C
Charge control voltage: 4.2 V
End-of-charge current: 0.05 C
Discharging method: CC
Discharging rate: 0.1 C
End-of-discharge voltage: 2.5 V

### <<Storage Characteristics Test>>

For Example 1-1, a storage characteristics test was performed. In the storage characteristics test, the secondary battery prepared as mentioned above was charged and discharged for the 1st cycle under the following conditions in an environment at 23° C., and the discharge capacity before storage was measured.
Charging method: CCCV
Charging rate: 0.1 C
Charge control voltage: 4.2 V
End-of-charge current: 0.05 C
Discharging method: CC
Discharging rate: 0.1 C
End-of-discharge voltage: 2.5 V

Thereafter, the battery was allowed to stand in a thermostatic chamber, stored in an environment at 80° C. for 10 days, and then discharged under the following conditions, and the discharge capacity after the storage was measured. The charging and the discharging were performed in an environment at 23° C. The ratio of the discharge capacity before the storage to the discharge capacity after the storage was calculated as a storage retention ratio. More specifically, the storage retention ratio was calculated based on the calculation formula:

$$storage retention ratio ( \% ) = ( discharge capacity after storage / discharge capacity before storage ) \times 100.$$

Discharging method: CC
Discharging rate: 0.1 C
End-of-discharge voltage: 2.5 V

### <<Low-Temperature Load Characteristics Test>>

For Example 1-1, a low-temperature load characteristics test was performed. In the low-temperature load characteristics test, the secondary battery prepared as mentioned above was charged and discharged for the 1st cycle under the following conditions in an environment at 23° C. Thereafter, the secondary battery was charged and discharged from the 2nd cycle to the 100th cycle in an environment at −10° C. under the following conditions in the same manner as the charge-discharge for the 1st cycle. The ratio of the discharge capacity in the 100th cycle to the discharge capacity in the 1st cycle was calculated as a low-temperature load retention ratio. More specifically, the low-temperature load retention ratio was calculated based on the calculation formula: low-temperature load retention ratio (%)=(discharge capacity in 100th cycle/discharge capacity in 1st cycle)×100.
Charging method: CCCV
Charging rate: 0.1 C
Charge control voltage: 4.2 V
End-of-charge current: 0.05 C
Discharging method: CC
Discharging rate: 0.1 C
End-of-discharge voltage: 2.5 V

### Comparative Example 1-1

As shown in Table 2, in Comparative Example 1-1, a secondary battery was prepared, and subjected to the measurement and the tests in the same manner as the battery according to Example 1-1, except that the condition for charging and discharging the prepared laminate cell was changed to the charge-discharge condition D to prepare the secondary battery.

### Example 1-2

As shown in Table 2, in Example 1-2, a secondary battery was prepared, and subjected to the measurement and the tests in the same manner as the battery according to Example 1-1, except that the condition for charging and discharging the prepared laminate cell was changed to the charge-discharge condition B to prepare the secondary battery.

### Example 1-3

As shown in Table 2, in Example 1-3, a secondary battery was prepared, and subjected to the measurement and the tests in the same manner as the battery according to Example 1-1, except that the condition for charging and discharging the prepared laminate cell was changed to the charge-discharge condition C to prepare the secondary battery.

### Comparative Example 1-2

As shown in Table 2, in Comparative Example 1-2, a secondary battery was prepared, and subjected to the measurement and the tests in the same manner as the battery according to Example 1-1, except that the condition for charging and discharging the prepared laminate cell was changed to the charge-discharge condition E to prepare the secondary battery.

### Comparative Example 1-3

As shown in Table 2, in Comparative Example 1-3, a secondary battery was prepared, and subjected to the measurement and the tests in the same manner as the battery according to Comparative Example 1-2, except that the solvent of the electrolytic solution was changed to prepare the secondary battery.

### Example 1-4 to Example 1-39

In Example 1-4 to Example 1-39, secondary batteries were prepared, and subjected to the measurement and the tests in the same manner as the battery according to Example 1-1, except that an electrolytic solution was prepared by changing at least one of the particle size of the positive electrode active material particles, the content ratio of the lithium carbonate (Li₂CO₃) in the positive electrode active material layer, the content ratio of the lithium hydroxide (LiOH) in the positive electrode active material layer, the type and concentration of the electrolyte salt, the types of the solvent components of the electrolytic solution, and the ratios of the solvent components of the electrolytic solution.

As shown in Table 2, while Examples 1-1 to 1-39 with (I_{S1}+I_{S2})/I_{St}≤0.97 were Successfully Charged and Discharged, Comparative Examples 1-1 to 1-3 with (I_{S1}+I_{S2})/I_{St}>0.97 failed to be charged or discharged. Accordingly, it is determined that the ratio (I_{S1}+I_{S2})/I_{St}<0.97 allows the batteries to be charged and discharged.

As shown in Table 2, Examples 1-3 to 1-39 with (I_{F1}+I_{F2})/I_{Ft}≥0.80 have cycle retention ratios improved as compared with Examples 1-1 and 1-2 with (I_{F1}+I_{F2})/I_{Ft}<0.80. Accordingly, it is determined that the ratio (I_{F1}+I_{F2})/I_{Ft}≤0.80 allows the charge-discharge characteristics to be improved.

As shown in Table 2, Examples 1-1 and Examples 1˜4 to 1-39 with (I_{Al1}+I_{Al2})/I_{Alt}≤0.30 have storage retention ratios and low-temperature load retention ratios improved as compared with Examples 1-2 and 1-3 with (I_{Al1}+I_{Al2})/I_{Alt}≥0.30. Accordingly, it is determined that the ratio (I_{Al1}+I_{Al2})/I_{Alt}≥0.30 allows the charge-discharge characteristics to be improved.

As shown in Table 2, Examples 1-17 to 1-22 with at least one of the P2p spectrum and Bls spectrum detected in the XPS measurement have storage retention ratios improved as compared with Example 1-23 without any P2p spectrum detected. Accordingly, it is determined that the presence of at least one of phosphorus (P) and boron (B) on the surface of the positive electrode current collector allows the charge-discharge characteristics to be improved.

As shown in Table 2, Examples 1-17 to 1-22 with the electrolytic solution containing at least one substance of a lithium hexafluorophosphate, a lithium tetrafluoroborate, a lithium bis(oxalato) borate, and a lithium difluorophosphate, have storage retention ratios improved as compared with Example 1-23 containing none of the substances. Accordingly, it is determined that the electrolytic solution contains the substance described above, thereby allowing the charge-discharge characteristics to be improved.

As shown in Table 2, Examples 1-4 to 1-26, Examples 1-28 to 1-30, and Examples 1-32 to 1-39 with the content ratio of the lithium carbonate in the positive electrode active material layer being less than 1.0% by mass have cycle retention ratios and storage retention ratios improved as compared with Example 1-31 with the content ratio of lithium carbonate in the positive electrode active material layer being 1.0% by mass or more. Accordingly, it is determined that the content ratio of the lithium carbonate in the positive electrode active material layer is less than 1.0% by mass or less, thereby allowing the charge-discharge characteristics to be improved.

As shown in Table 2, Examples 1-4 to 1-26, Examples 1-28 to 1-30, and Examples 1-32 to 1-39 with the content ratio of the lithium hydroxide in the positive electrode active material layer being less than 1.0% by mass have cycle retention ratios and storage retention ratios improved as compared with Example 1-27 with the content ratio of lithium hydroxide in the positive electrode active material layer being 1.0% by mass or more.

Accordingly, it is determined that the content ratio of the lithium hydroxide in the positive electrode active material layer is less than 1.0% by mass or less, thereby allowing the charge-discharge characteristics to be improved.

As shown in Table 2, Examples 1-4 to 1-14 and Examples 1-16 to 1-39 with the content ratio of the lithium carbonate in the positive electrode active material layer being more than 0.05% by mass have low-temperature load retention ratios improved as compared with Example 1-15 with the content ratio of lithium carbonate in the positive electrode active material layer being 0.05% by mass or less. Accordingly, it is determined that the content ratio of the lithium carbonate in the positive electrode active material layer is more than 0.05% by mass or less, thereby allowing the charge-discharge characteristics to be improved.

As shown in Table 2, Examples 1-4 to 1-14 and Examples 1-16 to 1-39 with the content ratio of the lithium hydroxide in the positive electrode active material layer being more than 0.05% by mass have low-temperature load retention ratios improved as compared with Example 1-15 with the content ratio of lithium hydroxide in the positive electrode active material layer being 0.05% by mass or less. Accordingly, it is determined that the content ratio of the lithium hydroxide in the positive electrode active material layer is more than 0.05% by mass or less, thereby allowing the charge-discharge characteristics to be improved.

Table 3 is a table showing Example 2-1 to Example 2-37 and Comparative Example 2-1.

TABLE 3

| | Positive Electrode | | | | | | | |
|---|---|---|---|---|---|---|---|---|
| | Positive | | | | | | | |
| | Electrode | | | | Electrolytic Solution | | | |
| | Active | | | | Electrolyte | | | |
| | Material | | Li₂CO₃ | LiOH | Salt | | Solvent | Charge- |
| | | D₅₀ | (% by | (% by | (mol/kg) | | (mass | discharge |
| | Type | (μm) | mass) | mass) | LiFSI | LiPF₆ | ratio) | Condition |
| Example 2-1 | LMNC | 12 | 0.2 | 0.2 | 2.00 | — | EC:PrPr = 53:47 | A |
| Comparative | LMNC | 12 | 0.2 | 0.2 | 2.00 | — | EC:PrPr = 53:47 | D |
| Example 2-1 | | | | | | | | |
| Example 2-2 | LMNC | 12 | 0.2 | 0.2 | 2.00 | — | EC:PrPr = 53:47 | B |
| Example 2-3 | LMNC | 12 | 0.2 | 0.2 | 2.00 | — | EC:PrPr = 53:47 | C |
| Example 2-4 | LMNC | 12 | 0.2 | 0.2 | 2.00 | — | EC:PrPr = 34:66 | A |
| Example 2-5 | LMNC | 12 | 0.2 | 0.2 | 2.10 | — | EC:PrEt = 37:63 | A |
| Example 2-6 | LMNC | 12 | 0.2 | 0.2 | 2.10 | — | EC:AcPr = 37:63 | A |
| Example 2-7 | LMNC | 12 | 0.2 | 0.2 | 2.20 | — | EC:PrEt = 18:82 | A |
| Example 2-8 | LMNC | 12 | 0.2 | 0.2 | 2.20 | — | EC:AcPr = 18:82 | A |
| Example 2-9 | LMNC | 12 | 0.2 | 0.2 | 2.20 | — | EC:AcMe = 18:82 | A |
| Example 2-10 | LMNC | 12 | 0.2 | 0.2 | 2.20 | — | EC:AcEt = 18:82 | A |
| Example 2-11 | LMNC | 12 | 0.2 | 0.2 | 2.20 | — | EC:PrEt:DMC = 19:24:57 | A |
| Example 2-12 | LMNC | 12 | 0.2 | 0.2 | 2.20 | — | EC:AcPr:DMC = 19:24:57 | A |
| Example 2-13 | LMNC | 12 | 0.2 | 0.2 | 2.20 | — | EC:AcMe:DMC = 19:24:57 | A |
| Example 2-14 | LMNC | 12 | 0.2 | 0.2 | 2.20 | — | EC:AcEt:DMC = 19:24:57 | A |
| Example 2-15 | LMNC | 12 | 0.2 | 0.2 | 1.80 | 0.20 | EC:PrPr:DMC = 19:24:57 | A |
| Example 2-16 | LMNC | 12 | 0.2 | 0.2 | 1.60 | 0.40 | EC:PrPr:DMC = 19:24:57 | A |
| Example 2-17 | LMNC | 12 | 0.2 | 0.2 | 1.20 | 0.80 | EC:PrPr:DMC = 19:24:57 | A |
| Example 2-18 | LMNC | 12 | 0.2 | 0.2 | 1.40 | 0.20 | EC:PrPr:DMC = 19:24:57 | A |
| Example 2-19 | LMNO | 12 | 0.2 | 0.2 | 1.20 | 0.40 | EC:PrPr:DMC = 19:24:57 | A |
| Example 2-20 | LMNC | 12 | 0.2 | 0.2 | 1.00 | 0.60 | EC:PrPr:DMC = 19:24:57 | A |
| Example 2-21 | LMNC | 12 | 0.2 | 0.2 | 2.20 | — | EC:PrPr:DMC = 19:24:57 | A |
| Example 2-22 | LMNC | 12 | 0.2 | 0.3 | 2.20 | — | EC:PrPr:DMC = 19:24:57 | A |
| Example 2-23 | LMNC | 12 | 0.2 | 0.5 | 2.20 | — | EC:PrPr:DMC = 19:24:57 | A |
| Example 2-24 | LMNC | 12 | 0.2 | 0.7 | 2.20 | — | EC:PrPr:DMC = 19:24:57 | A |
| Example 2-25 | LMNC | 12 | 0.2 | 1.0 | 2.20 | — | EC:PrPr:DMC = 19:24:57 | A |
| Example 2-26 | LMNC | 12 | 0.3 | 0.2 | 2.20 | — | EC:PrPr:DMC = 19:24:57 | A |
| Example 2-27 | LMNC | 12 | 0.5 | 0.2 | 2.20 | — | EC:PrPr:DMC = 19:24:57 | A |
| Example 2-28 | LMNC | 12 | 0.7 | 0.2 | 2.20 | — | EC:PrPr:DMC = 19:24:57 | A |
| Example 2-29 | LMNC | 12 | 1.0 | 0.2 | 2.20 | — | EC:PrPr:DMC = 19:24:57 | A |
| Example 2-30 | LMNC | 12 | 0.5 | 0.5 | 2.20 | — | EC:PrPr:DMC = 19:24:57 | A |
| Example 2-31 | LMNC | 12 | 0.7 | 0.7 | 2.20 | — | EC:PrPr:DMC = 19:24:57 | A |
| Example 2-32 | LMNC | 6 | 0.2 | 0.2 | 2.20 | — | EC:PrPr:DMC = 19:24:57 | A |
| Example 2-33 | LMNC | 8 | 0.2 | 0.2 | 2.20 | — | EC:PrPr:DMC = 19:24:57 | A |
| Example 2-34 | LMNC | 14 | 0.2 | 0.2 | 2.20 | — | EC:PrPr:DMC = 19:24:57 | A |
| Example 2-35 | LMNC | 16 | 0.2 | 0.2 | 2.20 | — | EC:PrPr:DMC = 19:24:57 | A |
| Example 2-36 | LMNC | 20 | 0.2 | 0.2 | 2.20 | — | EC:PrPr:DMC = 19:24:57 | A |
| Example 2-37 | LMNC | 23 | 0.2 | 0.2 | 2.20 | — | EC:PrPr:DMC = 19:24:57 | A |

| | XPS Measurement | | | | Test Results | | |
|---|---|---|---|---|---|---|---|
| | | | | Presence | | | Low- |
| | | | | or | | Storage | temperature |
| | (I_{S1} + | (I_{F1} + | (I_{A11} + | Absence | Cycle | Retention | Load |
| | I_{S2})/ | I_{F2})/ | I_{A12})/ | of P2p or | Retention | Ratio | Retention |
| | I_{St} | I_{Ft} | I_{Alt} | B1s | Ratio (%) | (%) | Ratio (%) |
| Example 2-1 | 0.97 | 0.78 | 0.30 | N | 35 | 59 | 47 |
| Comparative | 0.99 | 0.76 | 0.26 | N | 0 | 0 | 0 |
| Example 2-1 | | | | | | | |
| Example 2-2 | 0.97 | 0.78 | 0.27 | N | 29 | 42 | 33 |
| Example 2-3 | 0.96 | 0.81 | 0.27 | N | 46 | 53 | 35 |
| Example 2-4 | 0.84 | 0.90 | 0.35 | N | 86 | 86 | 65 |
| Example 2-5 | 0.93 | 0.83 | 0.34 | N | 84 | 82 | 77 |
| Example 2-6 | 0.86 | 0.88 | 0.35 | K | 88 | 86 | 75 |
| Example 2-7 | 0.90 | 0.85 | 0.38 | N | 90 | 88 | 86 |
| Example 2-8 | 0.91 | 0.85 | 0.37 | N | 89 | 87 | 82 |
| Example 2-9 | 0.93 | 0.82 | 0.37 | N | 86 | 82 | 88 |
| Example 2-10 | 0.93 | 0.82 | 0.33 | N | 84 | 80 | 91 |
| Example 2-11 | 0.92 | 0.84 | 0.34 | N | 93 | 91 | 84 |
| Example 2-12 | 0.93 | 0.84 | 0.34 | N | 91 | 90 | 81 |
| Example 2-13 | 0.94 | 0.83 | 0.36 | N | 89 | 85 | 87 |
| Example 2-14 | 0.94 | 0.84 | 0.36 | N | 89 | 85 | 87 |
| Example 2-15 | 0.82 | 0.92 | 0.62 | Y | 90 | 90 | 66 |
| Example 2-16 | 0.80 | 0.9 | 0.55 | Y | 89 | 91 | 65 |
| Example 2-17 | 0.79 | 0.89 | 0.56 | Y | 87 | 92 | 62 |
| Example 2-18 | 0.85 | 0.93 | 0.6 | Y | 86 | 88 | 70 |
| Example 2-19 | 0.83 | 0.91 | 0.53 | Y | 86 | 89 | 68 |
| Example 2-20 | 0.82 | 0.9 | 0.54 | Y | 85 | 91 | 65 |
| Example 2-21 | 0.90 | 0.85 | 0.35 | N | 91 | 89 | 67 |
| Example 2-22 | 0.90 | 0.85 | 0.35 | N | 88 | 86 | 64 |
| Example 2-23 | 0.90 | 0.85 | 0.35 | N | 86 | 81 | 63 |
| Example 2-24 | 0.90 | 0.85 | 0.35 | K | 82 | 74 | 61 |
| Example 2-25 | 0.90 | 0.85 | 0.35 | N | 70 | 53 | 55 |
| Example 2-26 | 0.90 | 0.85 | 0.35 | 4 | 88 | 86 | 64 |
| Example 2-27 | 0.90 | 0.85 | 0.35 | N | 87 | 83 | 63 |
| Example 2-28 | 0.90 | 0.85 | 0.35 | N | 80 | 76 | 60 |
| Example 2-29 | 0.90 | 0.85 | 0.35 | N | 68 | 48 | 55 |
| Example 2-30 | 0.90 | 0.85 | 0.35 | N | 86 | 82 | 61 |
| Example 2-31 | 0.90 | 0.85 | 0.35 | N | 80 | 73 | 55 |
| Example 2-32 | 0.90 | 0.85 | 0.35 | N | 90 | 85 | 74 |
| Example 2-33 | 0.90 | 0.85 | 0.35 | N | 92 | 87 | 70 |
| Example 2-34 | 0.90 | 0.85 | 0.35 | N | 92 | 90 | 63 |
| Example 2-35 | 0.90 | 0.85 | 0.35 | N | 90 | 92 | 61 |
| Example 2-36 | 0.90 | 0.85 | 0.35 | N | 90 | 92 | 59 |
| Example 2-37 | 0.90 | 0.85 | 0.35 | N | 90 | 92 | 57 |

### Example 2-1

As shown in Table 3, in Example 2-1, a secondary battery was prepared, and subjected to the measurement and the tests in the same manner as the battery according to Example 1-1, except that the positive electrode active material was changed to a second lithium composite oxide (LiMn_{0.4}Ni_{0.82}Co_{0.14}O₂, LMNC) powder.

### Comparative Example 2-1

As shown in Table 3, in Comparative Example 2-1, a secondary battery was prepared, and subjected to the measurement and the tests in the same manner as the battery according to Example 2-1, except that the condition for charging and discharging the prepared laminate cell was changed to the charge-discharge condition D to prepare the secondary battery.

### Example 2-2

As shown in Table 3, in Example 2-2, a secondary battery was prepared, and subjected to the measurement and the tests in the same manner as the battery according to Example 2-1, except that the condition for charging and discharging the prepared laminate cell was changed to the charge-discharge condition B to prepare the secondary battery.

### Example 2-3

As shown in Table 3, in Example 2-3, a secondary battery was prepared, and subjected to the measurement and the tests in the same manner as the battery according to Example 2-1, except that the condition for charging and discharging the prepared laminate cell was changed to the charge-discharge condition C to prepare the secondary battery.

### Example 2-4 to Example 2-37

In Example 2-4 to Example 2-37, secondary batteries were prepared, and subjected to the measurement and the tests in the same manner as the battery according to Example 2-1, except that an electrolytic solution was prepared by changing at least one of the particle size of the positive electrode active material particles, the content ratio of the lithium carbonate (Li₂CO₃) in the positive electrode active material layer, the content ratio of the lithium hydroxide (LiOH) in the positive electrode active material layer, the types of the solvent components of the electrolytic solution, and the ratios of the solvent components of the electrolytic solution.

As shown in Table 3, while Examples 2-1 to 2-37 with (I_{S1}+I_{S2})/I_{St}≤0.97 were successfully charged and discharged, Comparative Example 2-1 with (I_{S1}+I_{S2})/I_{St}>0.97 failed to be charged or discharged. Accordingly, it is determined that the ratio (I_{S1}+I_{S2})/I_{St}≤0.97 allows the batteries to be charged and discharged.

As shown in Table 3, Examples 2-3 to 2-37 with (I_{F1}+I_{F2})/I_{Ft}≥0.80 have cycle retention ratios improved as compared with Examples 2-1 and 2-2 with (I_{F1}+I_{F2})/I_{Ft}<0.80. Accordingly, it is determined that the ratio (I_{F1}+I_{F2})/I_{Ft}≥0.80 allows the charge-discharge characteristics to be improved.

As shown in Table 3, Examples 2-1 and Examples 2-4 to 2-37 with (I_{Al1}+I_{Al2})/I_{Alt}≥0.30 have storage retention ratios and low-temperature load retention ratio improved as compared with Examples 2-2 and 2-3 with (I_{Al1}+I_{Al2})/I_{Alt}<0.30. Accordingly, it is determined that the ratio (I_{Al1}+I_{Al2})/I_{Alt}≥0.30 allows the charge-discharge characteristics to be improved.

As shown in Table 3, Examples 2-15 to 2-20 with at least one of the P2p spectrum and Bls spectrum detected in the XPS measurement have storage retention ratios improved as compared with Example 2-21 without any P2p spectrum detected. Accordingly, it is determined that the presence of at least one of phosphorus (P) and boron (B) on the surface of the positive electrode current collector allows the charge-discharge characteristics to be improved.

As shown in Table 3, Examples 2-15 to 2-20 with the electrolytic solution containing at least one of a lithium hexafluorophosphate, a lithium tetrafluoroborate, a lithium bis(oxalato) borate, and a lithium difluorophosphate, have storage retention ratios improved as compared with Example 2-21 containing none of the substances. Accordingly, it is determined that the electrolytic solution contains the substance described above, thereby allowing the charge-discharge characteristics to be improved.

As shown in Table 3, Examples 2-4 to 2-24, Examples 2-26 to 2-28, and Examples 2-30 to 2-37 with the content ratio of the lithium carbonate in the positive electrode active material layer being less than 1.0% by mass have cycle retention ratios and storage retention ratios improved as compared with Example 2-29 with the content ratio of lithium carbonate in the positive electrode active material layer being 1.0% by mass or more. Accordingly, it is determined that the content ratio of the lithium carbonate in the positive electrode active material layer is less than 1.0% by mass or less, thereby allowing the charge-discharge characteristics to be improved.

As shown in Table 3, Examples 2-4 to 2-24, Examples 2-26 to 2-28, and Examples 2-30 to 2-37 with the content ratio of the lithium hydroxide in the positive electrode active material layer being less than 1.0% by mass have cycle retention ratios and storage retention ratios improved as compared with Example 2-25 with the content ratio of lithium carbonate in the positive electrode active material layer being 1.0% by mass or more. Accordingly, it is determined that the content ratio of the lithium hydroxide in the positive electrode active material layer is less than 1.0% by mass or less, thereby allowing the charge-discharge characteristics to be improved.

Table 4 is a table showing Example 3-1 to Example 3-13.

TABLE 4

| | Positive Electrode | | | | Electrolytic Solution | | | | | |
|---|---|---|---|---|---|---|---|---|---|---|
| | Positive | | | | | | | | | |
| | Electrode | | | | | | | Additive | | |
| | Active | | | | Electrolyte | | | | Content | |
| | Material | | Li₂CO₃ | LiOH | Salt | | Solvent | | Ratio | Charge- |
| | | D₅₀ | (% by | (% by | (mol/kg) | | (mass | | (% by | discharge |
| | Type | (μm) | mass) | mass) | LiFSI | LiPF₆ | ratio) | Type | mass) | Condition |
| Example | LNCA | 12 | 0.2 | 0.2 | 2.20 | — | EC:PrPr:DMC = | VC | 1.00 | A |
| 3-1 | | | | | | | 19:24:57 | | | |
| Example | LNCA | 12 | 0.2 | 0.2 | 2.20 | — | EC:PrPr:DMC = | VEC | 1.00 | A |
| 3-2 | | | | | | | 19:24:57 | | | |
| Example | LNCA | 12 | 0.2 | 0.2 | 2.20 | — | EC:PrPr:DMC = | MEC | 1.00 | A |
| 3-3 | | | | | | | 19:24:57 | | | |
| Example | LNCA | 12 | 0.2 | 0.2 | 2.20 | — | EC:PrPr:DMC = | FEC | 5.00 | A |
| 3-4 | | | | | | | 19:24:57 | | | |
| Example | LNCA | 12 | 0.2 | 0.2 | 2.20 | — | EC:PrPr:DMC = | DFEC | 5.00 | A |
| 3-5 | | | | | | | 19:24:57 | | | |
| Example | LNCA | 12 | 0.2 | 0.2 | 2.20 | — | EC:PrPr:DMC = | PS | 1.00 | A |
| 3-6 | | | | | | | 19:24:57 | | | |
| Example | LNCA | 12 | 0.2 | 0.2 | 2.20 | — | EC:PrPr:DMC = | PRS | 1.00 | A |
| 3-7 | | | | | | | 19:24:57 | | | |
| Example | LNCA | 12 | 0.2 | 0.2 | 2.20 | — | EC:PrPr:DMC = | CD | 1.00 | A |
| 3-8 | | | | | | | 19:24:57 | | | |
| Example | LNCA | 12 | 0.2 | 0.2 | 2.20 | — | EC:PrPr:DMC = | SA | 0.50 | A |
| 3-9 | | | | | | | 19:24:57 | | | |
| Example | LNCA | 12 | 0.2 | 0.2 | 2.20 | — | EC:PrPr:DMC = | PSAH | 0.50 | A |
| 3-10 | | | | | | | 19:24:57 | | | |
| Example | LNCA | 12 | 0.2 | 0.2 | 2.20 | — | EC:PrPr:DMC = | DTD | 0.50 | A |
| 3-11 | | | | | | | 19:24:57 | | | |
| Example | LNCA | 12 | 0.2 | 0.2 | 2.20 | — | EC:PrPr:DMC = | SN | 1.00 | A |
| 3-12 | | | | | | | 19:24:57 | | | |
| Example | LNCA | 12 | 0.2 | 0.2 | 2.20 | — | EC:PrPr:DMC = | HMI | 1.00 | A |
| 3-13 | | | | | | | 19:24:57 | | | |

| | XPS Measurement | | | | Test Results | | |
|---|---|---|---|---|---|---|---|
| | | | | Presence | | | Low- |
| | | | | or | | | temperature |
| | (I_{S1} + | (I_{F1} + | (I_{A11} + | Absence | Cycle | Storage | Load |
| | I_{S2})/ | I_{F2})/ | I_{A12})/ | of P2p or | Retention | Retention | Retention |
| | I_{St} | I_{Ft} | I_{Alt} | B1s | Ratio (%) | Ratio (%) | Ratio (%) |
| Example | 0.90 | 0.85 | 0.35 | N | 92 | 88 | 62 |
| 3-1 | | | | | | | |
| Example | 0.90 | 0.85 | 0.35 | N | 90 | 88 | 64 |
| 3-2 | | | | | | | |
| Example | 0.90 | 0.85 | 0.35 | N | 90 | 88 | 64 |
| 3-3 | | | | | | | |
| Example | 0.90 | 0.85 | 0.35 | N | 94 | 87 | 64 |
| 3-4 | | | | | | | |
| Example | 0.90 | 0.85 | 0.35 | N | 95 | 87 | 62 |
| 3-5 | | | | | | | |
| Example | 0.90 | 0.85 | 0.35 | N | 90 | 91 | 63 |
| 3-6 | | | | | | | |
| Example | 0.90 | 0.85 | 0.35 | N | 90 | 91 | 62 |
| 3-7 | | | | | | | |
| Example | 0.90 | 0.85 | 0.35 | N | 90 | 89 | 64 |
| 3-8 | | | | | | | |
| Example | 0.90 | 0.85 | 0.35 | N | 90 | 89 | 61 |
| 3-9 | | | | | | | |
| Example | 0.90 | 0.85 | 0.35 | N | 91 | 91 | 68 |
| 3-10 | | | | | | | |
| Example | 0.90 | 0.85 | 0.35 | N | 88 | 88 | 66 |
| 3-11 | | | | | | | |
| Example | 0.90 | 0.85 | 0.35 | N | 89 | 89 | 64 |
| 3-12 | | | | | | | |
| Example | 0.90 | 0.85 | 0.35 | N | 89 | 88 | 64 |
| 3-13 | | | | | | | |

### Example 3-1 to Example 3-13

As shown in Table 4, in Example 3-1 to Example 3-13, secondary batteries were prepared, and subjected to the measurement and the tests in the same manner as the battery according to Example 1-23 except that an additive was added to the electrolytic solution at the content ratio shown in Table 4, for preparing the secondary batteries.

As shown in Table 4, Examples 3-1 to 3-13 with the electrolytic solution containing the additive, which was at least one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, and an isocyanate compound, have cycle retention ratios and storage retention ratios improved as compared with Example 1-23 containing no additive. Accordingly, it is determined that the electrolytic solution contains the additive described above, thereby allowing the charge-discharge characteristics to be improved.

Table 5 is a table showing Example 4-1 to Example 4-3.

TABLE 5

| | Positive Electrode | | | | | | | | |
|---|---|---|---|---|---|---|---|---|---|
| | Positive | | | | | | | | |
| | Electrode | | | | Electrolytic Solution | | | | |
| | Active | | | | Electrolyte | | | | Content |
| | Material | | Li₂CO₃ | LiOH | Salt | | Solvent | | Ratio |
| | | D₅₀ | (% by | (% by | (mol/kg) | | (mass | Additive | (% by |
| | Type | (μm) | mass) | mass) | LiFSI | LiPF₆ | ratio) | Type | mass) |
| Example | LNCA | 12 | 0.2 | 0.2 | 2.20 | — | EC:PrPr:DMC = | LiPF₂O₂ | 0.50 |
| 4-1 | | | | | | | 19:24:57 | | |
| Example | LNCA | 12 | 0.2 | 0.2 | 2.20 | — | EC:PrPr:DMC = | LiBF₄ | 1.00 |
| 4-2 | | | | | | | 19:24:57 | | |
| Example | LNCA | 12 | 0.2 | 0.2 | 2.20 | — | EC:PrPr:DMC = | LiBOB | 0.50 |
| 4-3 | | | | | | | 19:24:57 | | |

| | | XPS Measurement | | | | Test Results | | |
|---|---|---|---|---|---|---|---|---|
| | | | | | Presence | | | Low- |
| | | | | | or | | | temperature |
| | Charge- | (I_{S1} + | (I_{F1} + | (I_{A11} + | Absence | Cycle | Storage | Load |
| | discharge | I_{S2})/ | I_{F2})/ | I_{A12})/ | of P2p | Retention | Retention | Retention |
| | Condition | I_{St} | I_{Ft} | I_{Alt} | or B1s | Ratio (%) | Ratio (%) | Ratio (%) |
| Example | A | 0.90 | 0.85 | 0.35 | Y | 90 | 88 | 68 |
| 4-1 | | | | | | | | |
| Example | A | 0.90 | 0.85 | 0.35 | Y | 89 | 88 | 64 |
| 4-2 | | | | | | | | |
| Example | A | 0.90 | 0.85 | 0.35 | Y | 92 | 90 | 62 |
| 4-3 | | | | | | | | |

### Example 4-1 to Example 4-3

As shown in Table 5, in Example 4-1 to Example 4-3, secondary batteries were prepared, and subjected to the measurement and the tests in the same manner as the battery according to Example 1-23 except that an additive was added to the electrolytic solution at the content ratio shown in Table 5, for preparing the secondary batteries.

As shown in Table 5, Examples 4-1 to 4-3 with at least one of the P2p spectrum and Bls spectrum detected in the XPS measurement have storage retention ratios improved as compared with Example 1-23 without any P2p spectrum detected. Accordingly, it is determined that the presence of at least one of phosphorus (P) and boron (B) on the surface of the positive electrode current collector allows the charge-discharge characteristics to be improved.

As shown in Table 5, Examples 4-1 to 4-13 with the electrolytic solution containing the additive, which was at least one of a lithium hexafluorophosphate, a lithium tetrafluoroborate, a lithium bis(oxalato) borate, and a lithium difluorophosphate, have storage retention ratios improved as compared with Example 1-23 containing no additive. Accordingly, it is determined that the electrolytic solution contains the additive described above, thereby allowing the charge-discharge characteristics to be improved.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode, and
an electrolytic solution,
wherein the positive electrode includes:
a positive electrode current collector including aluminum; and
a positive electrode active material layer provided on the positive electrode current collector,
the positive electrode active material layer includes a lithium-containing compound, a lithium carbonate, and a lithium hydroxide,
the electrolytic solution contains an electrolyte and a solvent, the electrolyte contains a bis(fluorosulfonyl)imide salt,
a surface of the positive electrode current collector includes sulfur,
an S2p photoelectron spectrum obtained by X-ray photoelectron spectroscopy for the surface of the positive electrode current collector has a first signal with a peak in a range of 164.1 eV or more and 164.5 eV or less and a second signal with a peak in a range of 168.9 eV or more and 169.3 eV or less, and
a ratio of a sum of a signal intensity of the first signal and a signal intensity of the second signal to a sum total of signal intensities of the S2p photoelectron spectrum is 0.97 or less.

2. The secondary battery according to claim 1, wherein
the surface of the positive electrode current collector further includes fluorine,
an F1s photoelectron spectrum obtained by the X-ray photoelectron spectroscopy for the surface of the positive electrode current collector has a third signal with a peak at 685.7 eV or more and 686.1 eV or less and a fourth signal with a peak at 687.4 eV or more and 687.8 eV or less, and
a ratio of a sum of a signal intensity of the third signal and a signal intensity of the fourth signal to a sum total of signal intensities of the F1s photoelectron spectrum is 0.80 or more.

3. The secondary battery according to claim 1, wherein
the surface of the positive electrode current collector further includes aluminum,
an Al2p photoelectron spectrum obtained in by the X-ray photoelectron spectroscopy for the surface of the positive electrode current collector has a fifth signal with a peak at 75.4 eV or more and 75.8 eV or less and a sixth signal with a peak at 76.4 eV or more and 76.8 eV or less, and
a ratio of a sum of a signal intensity of the fifth signal and a signal intensity of the sixth signal to a sum total of signal intensities of an Al2p photoelectron spectrum is 0.30 or more.

4. The secondary battery according to claim 1, wherein the surface of the positive electrode current collector further includes at least one of boron and phosphorus.

5. The secondary battery according to claim 1, wherein a content ratio of the lithium carbonate in the positive electrode active material layer is more than 0.05% by mass and less than 1.0% by mass.

6. The secondary battery according to claim 1, wherein a content ratio of the lithium hydroxide in the positive electrode active material layer is more than 0.05% by mass and less than 1.0% by mass.

7. The secondary battery according to claim 1,
wherein the lithium-containing compound includes at least one of a first lithium composite oxide represented by the formula (1) and a second lithium composite oxide represented by the formula (2): 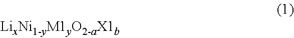
where M1 is at least one of Co, Mn, Mg, Ba, Al, B, Ti, V, Cr, Fe, Cu, Zn, Zr, Mo, Sn, Ca, Sr, W, Na, K, Nb, Ta, and a rare earth element, X1 is at least one of F, Cl, Cr, I, P, S, and Si, and x, y, a, and b satisfy 0.9≤x≤1.1, 0.005≤y≤0.5, −0.1≤a≤0.2, and 0≤b≤0.1, 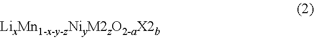
where M2 is at least one of Co, Mg, Ba, Al, B, Ti, V, Cr, Fe, Cu, Zn, Zr, Mo, Sn, Ca, Sr, W, Na, K, Nb, Ta, and a rare earth element, X2 is at least one of F, Cl, Cr, I, P, S, and Si, and x, y, Z, a, and b satisfy 0<x≤0.3, 0.3≤y≤0.9, 0≤z≤0.5, −0.1≤a≤0.2, and 0≤b≤0.1.

8. The secondary battery according to claim 1, wherein the electrolytic solution includes light metal ions as cations.

9. The secondary battery according to claim 8, wherein the light metal ions include lithium ions.

10. The secondary battery according to claim 9, wherein a content ratio of a lithium bis(fluorosulfonyl)imide in the electrolytic solution is 1.0 mol/kg or more and 3.0 mol/kg or less.

11. The secondary battery according to claim 1, wherein the electrolytic solution further includes at least one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, and an isocyanate compound.

12. The secondary battery according to claim 1, wherein the electrolytic solution further includes at least one of a lithium hexafluorophosphate, a lithium tetrafluoroborate, a lithium bis(oxalato) borate, and a lithium difluorophosphate.

13. The secondary battery according to claim 1, wherein the secondary battery is a lithium ion secondary battery.

14. The secondary battery according to claim 5, wherein the content ratio of the lithium hydroxide in the positive electrode active material layer ranges from 0.05% by mass to 1.0% by mass.

15. The secondary battery according to claim 12, wherein the surface of the positive electrode current collector further includes one or both of boron and phosphorous.
